(19) United States
(12) Patent Application Publication
(10) Pub. No.: US 2026/0025594 A1
(43) Pub. Date: Jan. 22, 2026

(54) DETECTION OF FLICKER IN CAMERA IMAGERY

(71) Applicant: Intel Corporation, Santa Clara, CA (US)

(72) Inventors: Andrey Semenjatshenco, Giv'atayim (IL); Naor Cohen, Elyakhin (IL)

(73) Assignee: Intel Corporation, Santa Clara, CA (US)

(21) Appl. No.: 19/340,311

(22) Filed: Sep. 25, 2025

(51) Int. Cl. H04N 23/745; H04N 23/71; H04N 23/73

(52) U.S. Cl. CPC H04N 23/745; H04N 23/71; H04N 23/73

(57) ABSTRACT

Example systems, apparatus, articles of manufacture, and methods to detect flicker in computer imagery are disclosed. An example apparatus disclosed herein accesses a first image of a sequence of images from a camera. The disclosed example apparatus also selects a second image of the sequence of images relative to the first image based on an expected flicker cycle. The disclosed example apparatus further generates a flicker detection output based on the first image and the second image.

### BACKGROUND

Flicker in camera imagery refers to variations in brightness that arise due to a mismatch between the exposure timing of the camera and the frequency of artificial light source(s) illuminating the scene. Flicker can be especially pronounced with lighting source(s) powered by alternating current (AC), such as fluorescent lights, light emitting diode (LED) lights, etc., which emit light that fluctuates in intensity at the AC frequency, such as 50 Hz, 60 Hz, etc.

### BRIEF DESCRIPTION OF THE DRAWINGS

FIG. 1 is a block diagram of an example environment in which example flicker detection circuitry operates to detect flicker in camera imagery.

FIGS. 2-3 illustrates example image difference signals that can be used to detect flicker in camera imagery.

FIG. 4 is a block diagram of an example implementation of the flicker detection circuitry of FIG. 1.

FIG. 5 illustrates example image difference signals corresponding to different offsets between a current image and respective different previous images in a sequence of images from an example camera.

FIG. 6 illustrates example segmentation of a slice from an example difference signal based on zero crossings.

FIGS. 7-8 illustrate different example transformed signals generated from corresponding different slices segmented form an example difference signal.

FIG. 9 illustrates an example merged signal generated by merging slices segmented from difference signals corresponding to adjacent image frames, and an example transformed signal generated from the merged signal.

FIGS. 10-12 are flowcharts representative of example machine-readable instructions and/or example operations that may be executed, instantiated, and/or performed by example programmable circuitry to implement the flicker detection circuitry of FIG. 4.

FIG. 13 is a block diagram of an example processing platform including programmable circuitry structured to execute, instantiate, and/or perform the example machine-readable instructions and/or perform the example operations of FIGS. 10-12 to implement the flicker detection circuitry of FIG. 4.

FIG. 14 is a block diagram of an example implementation of the programmable circuitry of FIG. 13.

FIG. 15 is a block diagram of another example implementation of the programmable circuitry of FIG. 13.

FIG. 16 is a block diagram of an example software/firmware/instructions distribution platform (e.g., one or more servers) to distribute software, instructions, and/or firmware (e.g., corresponding to the example machine-readable instructions of FIGS. 10-12) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Flicker in camera imagery refers to variations in brightness that arise due to a mismatch between the exposure timing of the camera and the frequency of artificial light source(s) illuminating the scene. The frequency of the light source intensity fluctuations can be related to the AC frequency of the power source driving the light source. In rolling shutter cameras, which have a camera sensor that reads out image rows sequentially rather than capturing the entire frame at once, the light source intensity fluctuations interact with the row-by-row exposure process. As a result, different rows of the camera sensor may be exposed at different points in the light's intensity, or brightness, cycle, which can lead to a sinusoidal variation in brightness across rows. Such sinusoidal variation in brightness can manifest as horizontal banding or striping in a captured image.

Some flicker detection techniques detect image flicker by subtracting one captured image frame from an adjacent captured image frame to determine a difference image that may reveal any brightness changes between the frames. Some such flicker detection techniques may sum, or accumulate, the pixel values of the difference image (which are the pixel differences between the two consecutive captured images) across individual rows of the difference image to determine a respective total brightness change value for each row of the difference image. The row-wise sums of pixel differences result in a one-dimensional row-wise difference vector, also referred to as a one-dimensional row-wise difference signal, that reflects how brightness varies across image rows.

When flicker is present in the captured camera images, the row-wise difference vector/signal described above exhibits a sinusoidal shape characterized by identifiable features such as local maxima and minima arranged in patterns, such as two maxima separated by one minimum or one maximum separated by two minima. Such patterns correspond to the periodic modulation of brightness caused by the interaction of the rolling shutter readout and the fluctuating light intensity. Some flicker detection techniques exploit the regular periodicity of sinusoidal waves to estimate the flicker frequency by calculating the distance between extrema (maxima and minima) of the row-wise difference vector/signal to estimate the flicker period, and then inverting the estimated flicker period to obtain the estimated flicker frequency.

Example image flicker detection solutions disclosed herein provide several improvements over such examining flicker detection techniques. For example, some flicker detection solution disclosed herein determine a difference image for flicker analysis that is based on image frames selected to have an offset that aligns with a midpoint of a flicker cycle. Such image frame selection can improve the detectability of flicker relative to difference images computed using consecutive (or adjacent) image frames.

Some example flicker detection solutions disclosed herein analyze the row-wise difference vector/signal (e.g., which is computed from a difference image) by using zero crossings to extract one or more portions, referred to as slices herein, of the difference vector/signal. The extracted slice(s) could correspond to complete, full periods of sinusoidal waveforms at the flicker frequency. To detect if flicker is present, some such disclosed example flicker detection solutions transform the extracted slice(s) of the difference vector/signal (e.g., such as with a Fourier transform, a fast Fourier transform (FFT), etc.) to determine a transformed signal (e.g., a frequency transformed signal, a frequency domain signal, etc.). Such disclosed example flicker detection solutions identify a dominant component (e.g., dominant frequency component) of the transformed signal and analyze the dominant frequency component to determine whether flicker is present in the captured images. By extracting slice(s) of the difference vector/signal that could correspond to complete, full periods of sinusoidal waveforms at the flicker frequency, disclosed example flicker detection solutions reduce the likelihood that the transformed signal will exhibit sampling artifacts that could yield false dominant components and result in false flicker detections.

Furthermore, some example flicker detection solutions disclosed herein analyze temporal variations across multiple image frames to accurately detect flicker and, if present, the flicker frequency. For example, some flicker detection solutions disclosed herein concatenate the extracted slice(s) of the difference vectors/signals determined over multiple image frames to determine a concatenated difference vector/signal. Such disclosed example flicker detection solutions transform the concatenated difference vector/signal (e.g., such as with a Fourier transform, an FFT, etc.) to determine a transformed concatenated signal (e.g., a frequency transformed concatenated signal). Such disclosed example flicker detection solutions identify a dominant component (e.g., dominant frequency component) of the transformed concatenated signal and analyze the dominant frequency component to determine whether flicker is present in the captured images. Using such a concatenated signal increases the quantity of data that is transformed, thereby improving the resolution of the transformed concatenated signal relative to using a single extracted slice of a difference vector/signal. Such an increase in data quality and associated improvement in transform resolution can enable disclosed example flicker detection solutions to achieve highly accurate flicker frequency predictions with improved true positive rates and reduced false positives, thereby offering reliable flicker detection.

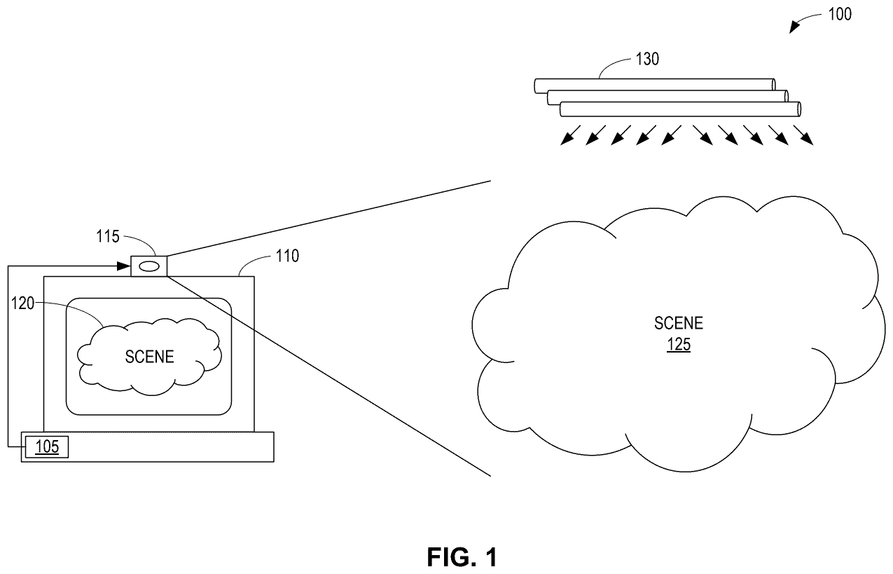

Turning to the figures, FIG. 1 is a block diagram of an example environment 100 in which example flicker detection circuitry 105 operates to detect flicker in camera imagery in accordance with teachings of this disclosure. In the illustrated example environment 100 of FIG. 1, the flicker detection circuitry 105 is included in an example compute device 110 to detect flicker in camera imagery from an example device camera 115 included in, coupled to, or otherwise associated with the compute device 110. The compute device 110 in the environment 100 is illustrated as an example laptop computer. However, the compute device 110 can be implemented by any type of compute device, such as, but not limited to, a server, a personal computer, a workstation, a mobile device (e.g., a cell phone, a smart phone, a tablet such as an iPad™), a personal digital assistant (PDA), a gaming console, a headset (e.g., an augmented reality (AR) headset, a virtual reality (VR) headset, etc.) or other wearable device, or any other type of computing and/or electronic device. Also, the device camera 115 in the environment 100 is illustrated as an example front-facing camera of the compute device 110. However, the device camera 115 can be implemented by any camera or other imaging device. Also, in some examples, the camera 115 is a stand-alone camera and the flicker detection circuitry 105 is included in or otherwise implemented by the camera 115.

In the illustrated example of FIG. 1, the device camera 115 captures example image(s) 120 of an example scene 125. For example, a captured image 120 can be a color image, a monochrome image, a thermal or infrared image, etc. In the illustrated example of FIG. 1, the scene 125 is illuminated by one or more example light sources 130. For example, the light source(s) 130 can include one or more fluorescent light sources (as shown), one or more LED light sources, one or more incandescent light sources, one or more infrared light sources, one or more ultraviolet light sources, etc. As such, in some examples, the light source(s) 130 are associated with an intensity (or brightness) fluctuation frequency that is based on the frequency of the AC power source driving the light source(s) 130, which may be 50 Hertz (Hz), 60 Hz, or some other frequency.

The flicker detection circuitry 105 of the illustrated example operates to detect flicker in the image(s) 120 captured by the camera 115. In some examples, if flicker is detected, the flicker detection circuitry 105 also estimates the flicker frequency. As described in further detail below, the flicker detection circuitry 105 of the illustrated example determines a difference image for flicker analysis that is based on image frames selected to have an offset that aligns or otherwise corresponds with a midpoint of an expected flicker cycle associated with the light source(s) 130. For example, the expected flicker cycle may be 50 Hz or 60 Hz in examples in which the light source(s) 130 are powered by an AC power source. As also described in further detail below, the flicker detection circuitry 105 of the illustrated example uses zero crossings of a difference vector/signal determined from the difference image to extract one or more slices (e.g., one or more portions) of the difference vector/signal that could correspond to complete, full periods of sinusoidal waveforms, which can be representative of flicker frequency. The flicker detection circuitry 105 of the illustrated example then transforms the extracted slice(s) of the difference vector/signal (e.g., with an FFT) and analyzes the dominant component (e.g., the dominant frequency component) of the resulting transformed vector/signal to detect if flicker is present and, if so, identify the flicker frequency. As further described below, the flicker detection circuitry 105 of the illustrated example concatenates the extracted slice(s) of the difference vectors/signals determined over multiple image frames to determine a concatenated difference vector/signal. The flicker detection circuitry 105 of the illustrated example then transforms the concatenated difference vector/signal (e.g., with an FFT) and analyzes the dominant component (e.g., the dominant frequency component) of the resulting transformed vector/signal to detect if flicker is present and, if so, identify the flicker frequency. Thus, the flicker detection circuitry 105 of the illustrated example combines temporal sinusoidal analysis, strategic frame selection, and FFT techniques to accurately identify and analyze flicker patterns.

In the illustrated example of FIG. 1, flicker detection circuitry 105 generates a flicker detection output that can be a signal, a value, an instruction, etc., that specifies, identifies or otherwise indicates whether flicker is detected in a given captured image 120 from the camera 115. In some examples, the flicker detection output also specifies, identifies or otherwise indicates a frequency of the flicker (e.g., the flicker frequency) if flicker is detected. In some examples, the flicker detection circuitry 105 and/or one or more other circuits use the flicker detection output to control operation of the camera 115 to mitigate the effects of flicker. For example, the flicker detection circuitry 105 and/or one or more other circuits can adjust an exposure setting (e.g., such as exposure timing, a single exposure setting, a multi-exposure setting, etc.) of the camera 115 if the flicker detection output indicates that flicker has been detected in the current image 120 from the camera 115. In some such examples, the adjustment can be based on the flicker frequency identified in the flicker detection output. For example, if flicker is detected, the flicker detection circuitry 105 and/or one or more other circuits can disable multi-exposure (also referred to a high dynamic range (HDR)) capture and revert to single exposure.

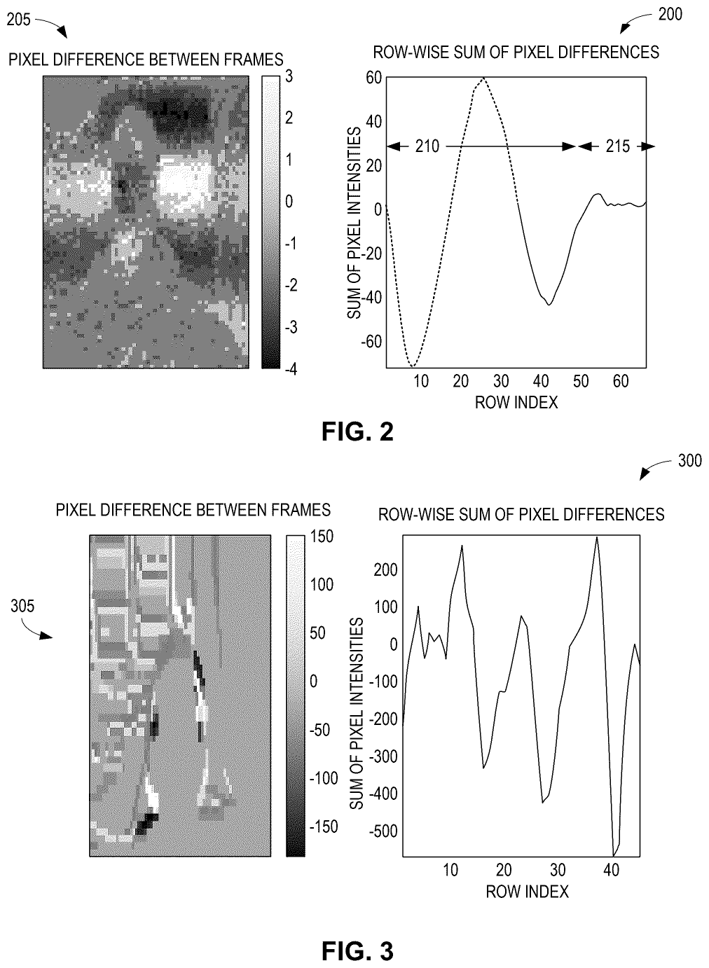

FIGS. 2-3 illustrates example image difference signals 200 and 300 that can be used to detect flicker in camera imagery. For example, FIG. 2 corresponds to an example in which flicker is present in the top portion of a current image frame 120. The flicker detection circuitry 105 determines the image difference signal 200 of the illustrated example by summing the pixel intensities across respective rows of an example difference image 205 that is based on the current image frame 120 and a selected preceding image from the camera 115. The resulting image difference signal 200 exhibits a strong sinusoidal modulation in an initial region 210 corresponding to the top rows of the image 120, and negligible signal values in a later region 215 corresponding to the bottom rows of the image 120. As such, the image difference signal 200 is representative of the presence of flicker in the top portion of the image 120 (e.g., corresponding to the rows represented in the region 210) and the absence of flicker in the bottom portion of the image 120 (e.g., corresponding to the rows represented in the region 215). The flicker detection circuitry 105 captures these patterns effectively, even when the flicker is localized to specific regions of the image rather than spread across the entire frame.

FIG. 3 corresponds to an example in which motion, and not flicker, introduces local changes in the intensity of the current image 120 captured by the camera 115. The flicker detection circuitry 105 determines the image difference signal 300 of the illustrated example by summing the pixel intensities across respective rows of an example difference image 305 that based on the current image frame 120 and a selected preceding image from the camera 115. As illustrated in the example of FIG. 3, although the motion introduces local changes in intensity as indicated by the fluctuations in the image difference signal 300, the absence of a consistent sinusoidal modulation prevents the flicker detection circuitry 105 from falsely classifying the frame as flickering. This is because the flicker detection circuitry 105 uses FFT analysis on complete sinusoidal wave periods, enabling the flicker detection circuitry 105 to analyze the full waveform shape rather than relying on local extrema as in other flicker detection techniques.

In contrast, other flicker detection techniques that estimate the flicker frequency using the minima and maxima of a difference signal may misinterpret motion-induced variations as flicker. This can lead to incorrect detection and cause the system to prematurely switch the camera from multi-exposure (e.g., HDR) to single exposure, thereby sacrificing HDR and causing an unnecessary loss of dynamic range in the captured image when there is no real flicker present.

Flicker detection as implemented by the flicker detection circuitry 105 mitigates this risk by extracting and concatenating complete sinusoidal periods, referred to as slices, from the difference signals 200/300 corresponding to a given frame and concatenating the slices, ensuring that detection is based on consistent, global frequency behavior rather than localized noise.

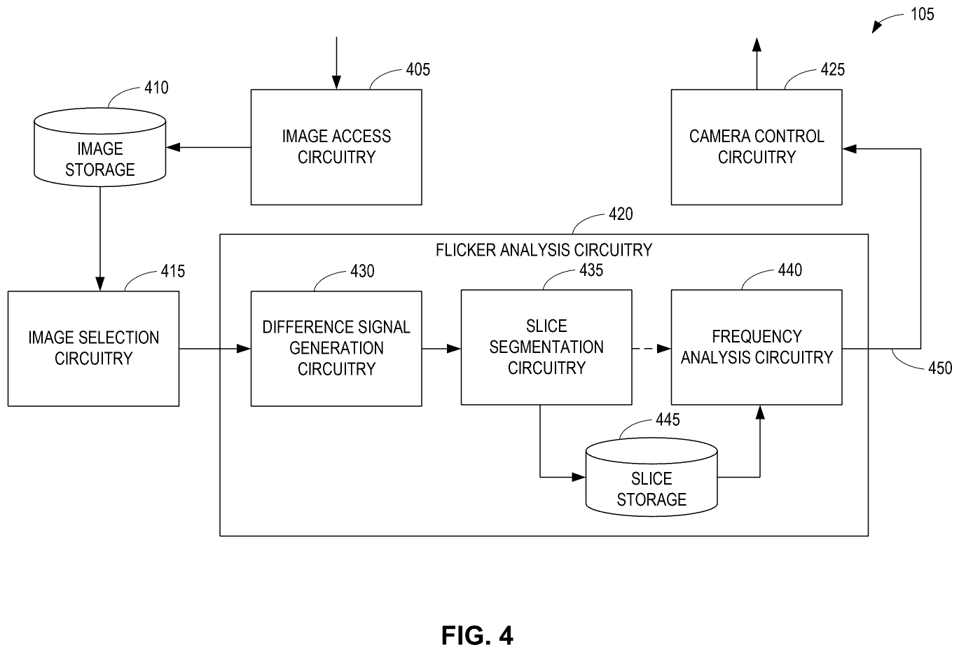

FIG. 4 is a block diagram of an example implementation of the flicker detection circuitry 105 of FIG. 1. The flicker detection circuitry 105 of FIG. 4 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the flicker detection circuitry 105 of FIG. 4 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers.

The example flicker detection circuitry 105 of FIG. 2 includes example image access circuitry 405, example image storage 410, example image selection circuitry 415, example flicker analysis circuitry 420 and example camera control circuitry 425. The flicker analysis circuitry 420 of the illustrated example further includes example difference signal generation circuitry 430, example slice segmentation circuitry 435, example frequency analysis circuitry 440 and example slice storage 445. The image access circuitry 405 of the illustrated example accesses (e.g., reads, retrieves, obtains, receives, etc.) the images 120 captured by the camera 115. For example, the image access circuitry 405 can access the images 120 in any format, such as, but not limited to, RGB format, YUV format, etc. In some examples, the image access circuitry 405 communicates with the camera 115 to access the captured images 120. In some examples, the camera 115 provides the captured images 120 to the compute device 110, and the image access circuitry 405 accesses the captured images 120 from the compute device 110 (e.g., via memory/storage of the compute device 110).

In the illustrated example, the image access circuitry 405 stores (e.g., writes) the captured images 120 from the camera 115 to the image storage 410. In this way, the flicker detection circuitry 105 has access to a sequence of image frames 120 from the camera 115, which includes a current image frame being analyzed for flicker and one or more previous image frames captured by the camera 115 before the current image frame. The reference data storage 410 can be implemented by any numbers and/or types of storage devices, memories, etc. For example, the reference data storage 410 can be implemented by one or more of the local memory 1313, the volatile memory 1314, the non-volatile memory 1316, and/or the mass storage discs or devices 1328 described in further detail below.

The image selection circuitry 415 of the illustrated example selects images to be used to determine difference images, such as the difference images 205 and/or 305, used by the flicker detection circuitry 105 to detect flicker in the captured images 120 from the camera 115. In the illustrated example, the image selection circuitry 415 implements an example frame selection process that enhances flicker visibility by identifying and selecting a previous image frame in a sequence of image frames 120 captured by the camera 115 that amplifies the sinusoidal modulation of flicker relative to a current image frame being analyzed. The image selection circuitry 415 achieves such amplification by evaluating a set of previous image frames relative to the current image frame 120 (e.g., from the image storage 410) and selecting a particular one of the previous image frames having an offset from the current image frame 120 that aligns (e.g., within a threshold range) with the flicker cycle's midpoint, thereby enhancing the detectable flicker effect. In some examples, the frame selection process implemented by the image selection circuitry 415 involves analyzing timing and brightness differences between the current image frame 120 and the previous image frames to select a particular previous image frame to ensure optimal flicker phase alignment and luminance consistency.

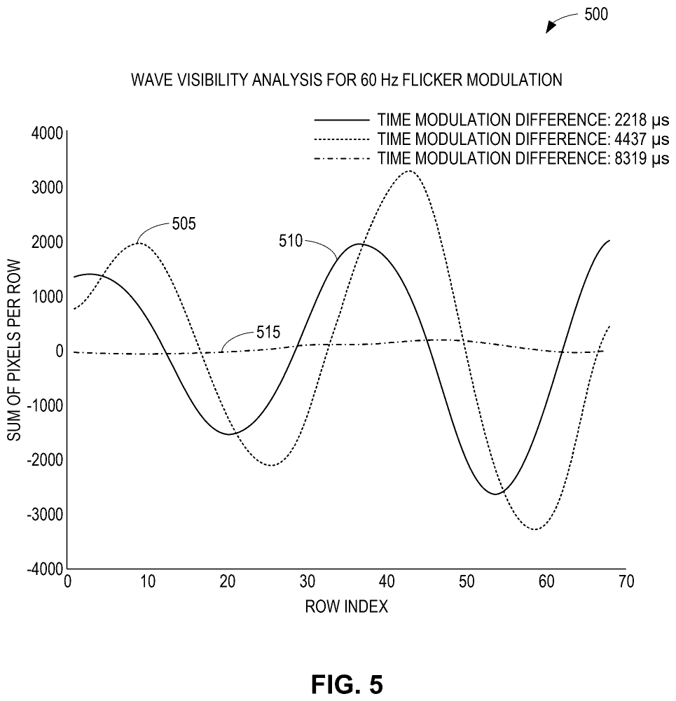

FIG. 5 illustrates an example graph 500 of example image difference signals 505-515 corresponding to different offsets between a current image frame and respective different previous image frames in a sequence of image frames 120 from the camera 115. The different image difference signals 505-515 demonstrate the importance that selecting a proper previous frame relative to the current image frame being analyzed has with respect to generating a difference image for the current image frame and generating the image difference signal from that difference image. In particular, the graph 500 of FIG. 5 illustrates the differences in flicker visibility across the different image difference signals 505-515 due to different timestamp offsets of the current frame relative to respective different previous image frames selected to generate the different image difference signals 505-515. (In FIG. 5, the timestamp offsets are represented as time modulation differences that convert integer timestamp offset values to time differences in seconds. In some examples, the image selection circuitry 415 computes a time modulation difference between two timestamps by multiplying the integer offset (or difference) between the timestamps by the frame period (e.g., the inverse of the frame rate) of the sequence of image frames 120.)

Examining FIG. 5 in detail, the graph 500 assumes a flicker frequency of 60 Hz, which corresponds to a flicker period of 8333 microseconds. (The flicker frequency refers to the AC power frequency. However, the frequency of the light flickering is assumed to be twice the AC power frequency as the light flickers once per each half-cycle of the AC power. The, the flicker period for a 60 Hz AC source is 1/(2×60)= 1/120=8333 microseconds. Similarly, the flicker period for a 50 Hz AC source is 1/(2×50)= 1/100=1.0 milliseconds.) As shown in the graph 500 of FIG. 5, the visibility of the flicker effect peaks in the example image difference signal 505, which is based on a timestamp offset (e.g., time modulation difference) between the current image frame and the selected previous image frame that is approximately at the midpoint of the flicker period (4166.5 microseconds), which aligns the flicker patterns of the current and selected image frames. Thus, the image selection circuitry 415 attempts to select a previous image frame such that its timestamp is aligned with the midpoint of the flicker cycle relative to the current image frame. In contrast, selection of a previous image frame having timestamp offset near the end of the flicker cycle, such as in the case of the image difference signal 515 that is based on a timestamp offset (e.g., time modulation difference) between the current image frame and the selected previous image frame of 8319 microseconds, results in the flicker effect being barely visible in the image difference signal 515. These results underscore the importance that proper selection of a previous image frame with precise frame alignment within the flicker cycle relative to the current frame has on enhancing flicker visibility. By carefully selecting frames that coincide with key points in the flicker cycle, the image selection circuitry 415 can improve the detection and analysis of flicker effects.

Returning to FIG. 4, and with the foregoing in mind, example pseudocode for an example frame selection process implemented by the image selection circuitry 415 is provided in Table 1 below.

TABLE 1
Algorithm 1 Frame Selection Process

| | |
|---|---|
| 1: | Initialize selection metrics |
| 2: | Retrieve current frame's timestamp and brightness |
| 3: | for each previous frame in a short window do |
| 4: | Compute time difference from current frame |
| 5: | Calculate modulation for 50Hz and 60Hz flicker cycles |
| 6: | Evaluate alignment with flicker cycle midpoint (T/2) |
| 7: | Estimate modulation strength based on timestamp difference |
| 8: | Compare brightness scaled by exposure to current frame |
| 9: | if modulation is strong and brightness matches well then |
| 10: | Update best frame candidate |
| 11: | end if |
| 12: | end for |
| 13: | return selected frame offset and exposure adjustment |

With reference to Table 1, the example frame selection process begins at operation 1 in which the image selection circuitry 415 initializes one or more selection metrics, such as one more thresholds, threshold ranges, etc., described below. At operation 2 of the example frame selection process, the image selection circuitry 415 accesses the timestamp of the current image frame 120 being analyzed for flicker. In some examples, the image selection circuitry 415 also computes or otherwise obtains the brightness of the current image frame 120.

Next, at operation 3 of the example frame selection process, the image selection circuitry 415 begins iterating over a set of previous image frames within a window relative to the current image frame. In some examples, the window is configurable and one of the selection metrics initialized at operation 1.

Next, at operation 4 of the example frame selection process, the image selection circuitry 415 computes the time difference between the current image frame and the next previous image frame corresponding to the present process iteration. In some examples, the image selection circuitry 415 computes the time difference by computing the timestamp difference, or timestamp offset, between the next previous image frame in the window and the current image frame. For example, the image selection circuitry 415 computes the timestamp difference (or offset) by subtracting the timestamp of the current frame by the timestamp of the next previous image frame corresponding to the present process iteration. In some examples, the image selection circuitry 415 then converts this timestamp difference to a time difference by scaling the timestamp difference between the timestamp of the current image frame and the timestamp of this previous image frame by the period of an image frame (e.g., which is the inverse of the frame rate of the image frames 120 from the camera 115). Alternatively, in some examples, the image selection circuitry 415 multiplies the respective timestamps of the current image frame and the previous image frame by the frame period to convert the timestamps to relative times (e.g., in seconds) associated with the respective image frames, and then computes the difference between these relative times as the time difference between the between the next previous image frame and the current image frame.

At operation 5 of the example frame selection process, the image selection circuitry 415 calculates the flicker period of one or more expected flicker cycles. For example, the image selection circuitry 415 may calculate the flicker periods for expected flicker cycles of 50 Hz and 60 Hz assuming that the light source(s) 130 are powered by AC power sources having AC frequencies in the range of 50 to 60 Hz.

At operation 6 of the example frame selection process, the image selection circuitry 415 evaluates the alignment of given previous image frame under examination in this process iteration to the midpoint(s) of the expected flicker cycle(s) relative to the current image frame. For example, for each expected flicker cycle (e.g., 50 Hz and 60 Hz), the image selection circuitry 415 may compute a respective error difference between the midpoint of the that flicker cycle and the timestamp offset (or time modulation difference) between the current and previous image frames. At operation 7 of the example frame selection process, the image selection circuitry 415 estimates a modulation strength for the given previous image frame under examination based on the error difference(s) determined at operation 6. For example, in the case of one expected flicker cycle to consider (e.g., such as 50 Hz or 60 Hz), the image selection circuitry 415 may determine the modulation strength for the given previous image frame under examination as the inverse or some other function of the error difference associated with the given previous image frame under examination. As another example, in the case of multiple expected flicker cycles to consider (e.g., such as 50 Hz and 60 Hz), the image selection circuitry 415 may determine the modulation strength for the given previous image frame under examination by combining (e.g., averaging) the error differences associated with the respective expected flicker cycles and computing the inverse or some other function of the combined error differences.

In some examples, at operation 7 of the example frame selection process, the image selection circuitry 415 computes or otherwise obtains the brightness of the given previous image frame under examination. If an exposure setting of the camera 115 was changed between the given previous image frame under examination and the current frame, the image selection circuitry 415 may also scale the brightness of the previous image frame based its exposure setting (e.g., such as by scaling the brightness of the previous image frame by a ratio of the exposure associated with the current image frame divided by the exposure associated with the previous image frame).

At operation 9 of the example frame selection process, the image selection circuitry 415 determines whether the given previous image frame under examination has the strongest modulation strength of the previous image frames examined so far. In some examples, the image selection circuitry 415 also determines whether the modulation strength of the given previous image frame under examination satisfies a first threshold, which may be configurable and one of the selection metrics initialized at operation 1. In some examples, the image selection circuitry 415 further determines whether the brightness of the previous image frame based (possibly after scaling, as described above) matches well with the brightness of the current image frame, such as by being within a second threshold range, which may be configurable and one of the selection metrics initialized at operation 1.

If the given previous image frame under examination has the strongest modulation strength among the previous image frames examined so far, and if, in some examples, the modulation strength of the given previous image frame under examination satisfies the first threshold, and if, in some examples, the brightness of the previous image frame is within the second threshold range of the brightness of the current image frame, the example frame selection process proceeds to operation 10. At operation 10, the image selection circuitry 415 saves the given previous image frame under examination as the best previous image frame candidate. This is because the given previous image frame under examination has the strongest modulation strength among the previous image frames examined so far and, thus, has an offset relative to the current image frame that is closest to the midpoint of the expected flicker cycle among the previous image frames examined so far. Also, the brightness check ensures that a substantial change in the scene or the camera configuration has not occurred between the given previous image frame under examination and the current image frame, which would make the given previous image frame a poor candidate for use in analyzing flicker associated with the current image frame.

Next, at operations 11 and 12 of the example frame selection process, the image selection circuitry 415 continues iterating over the previous image frames within the window until all the previous image frames within the window have been exampled. Then, at operation 13 of the example frame selection process, the image selection circuitry 415 returns, or outputs, the final best previous image frame candidate as the selected previous image frame. In some examples, the image selection circuitry 415 also returns, or outputs, the exposure adjustment for the selected previous image frame (e.g., the ratio of the exposure associated with the current image frame divided by the exposure associated with the selected previous image frame). This exposure adjustment can be used to match the brightness of the selected previous image frame with the brightness of the current image frame when determining the difference image between the two frames, as described in further detail below.

The flicker analysis circuitry 420 of the illustrated example uses the current image frame 120 and the previous image frame selected by the image selection circuitry 415 to analyze whether flicker is present in the current image frame 120. To begin this analysis, the difference signal generation circuitry 430 of the flicker analysis circuitry 420 computes a difference image between the current image frame 120 and the previous image frame selected by the image selection circuitry 415 based on the expected flicker cycle(s). For example, the difference signal generation circuitry 430 can compute the difference image such that the pixels of the difference image correspond to the pixel-wise differences between the pixels of current image frame 120 and pixels of the selected previous image frame. Example difference images determined by the difference signal generation circuitry 430 include the example difference images 205 and 305 described above.

The difference signal generation circuitry 430 then computes a difference signal (also referred to as a difference vector, a difference waveform, etc.) based on the difference image computed between the current image frame 120 and the previous image frame selected by the image selection circuitry 415 based on the expected flicker cycle(s). For example, the difference signal generation circuitry 430 sums, or accumulates, the pixel values of the difference image (which are the pixel differences between the current image frame and the selected previous image frame) across individual rows of the difference image to determine a respective total brightness change value for each row of the difference image. The difference signal generation circuitry 430 then arranges the row-wise sums of pixel differences sequentially to form a one-dimensional difference signal (also referred to as a difference vector, a difference waveform, etc.) that reflects how brightness varies across image rows. Example difference signals determined by the difference signal generation circuitry 430 include the example difference signals 200 and 300 described above.

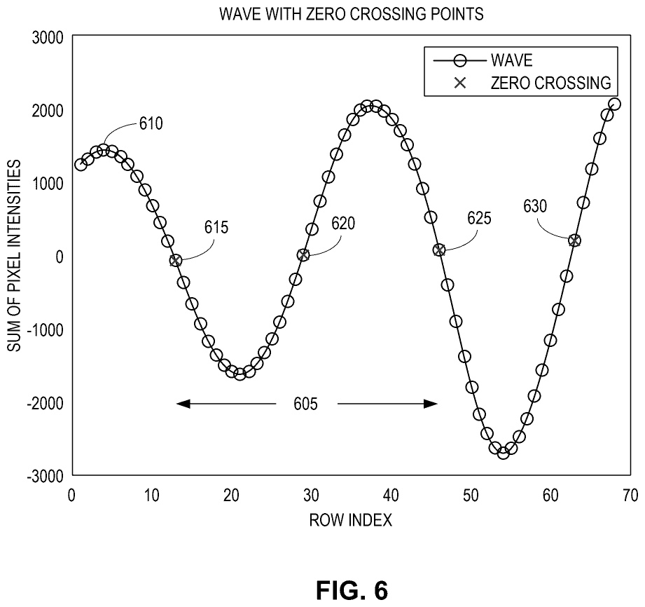

The slice segmentation circuitry 435 of the flicker analysis circuitry 420 segments the difference signals generated by the difference signal generation circuitry 430 into one or more slices, respectively, that correspond to complete (e.g., full) periods of potential flicker cycles. The slice segmentation circuitry 435 segments slice(s) from a difference signal based on zero crossings in the difference signal. FIG. 6 illustrates segmentation of an example slice 605 from an example difference signal 610 based on zero crossings. Zero crossings in the difference signal 610 are samples, or indices, of the difference signal 610 at which the values of the difference signal 610 transition from positive to negative values, or from negative to positive values. The difference signal 610 of FIG. 6 includes four (4) example zero crossing labeled 615-630. In some examples, the slice segmentation circuitry 435 extracts slice(s) from the difference signal 610 by filtering the difference signal 610 using a filter, such as a moving average filter, a low-pass filter, etc., to reduce noise. The slice segmentation circuitry 435 then identifies the samples, or indices, at which the difference signal 610 crosses zero, which corresponds to the zero crossing 615-630 in the example of FIG. 6.

The slice segmentation circuitry 435 then uses the zero crossings 615-630 to segment the difference signal 610 into slice(s), such as the example slice 605, the corresponds to a complete (e.g., full) period of a potential flicker cycle. As illustrated above by the example difference signal 200 of FIG. 2, the presence of flicker in the current image frames results in sinusoidal variations in the difference signal 610. A complete sinusoidal period crosses zero three times at the indices nπ, (n+1)π and (n+2)π (e.g., such as 0, π, and 2π for n=0). Thus, the slice segmentation circuitry 435 segments the difference signal 610 into slice(s), such as the slice 605, that include three (3) consecutive zero crossings. Depending on the length (e.g., duration) of the difference signal 610, the slice segmentation circuitry 435 may segment the difference signal 610 into multiple slices, which may be non-overlapping or overlapping, and which each include three (3) consecutive zero crossings.

As described in further detail below, the flicker analysis circuitry 420 employs a transform, such as an FFT, to detect flicker in difference signals, such as the difference signal 610. Limiting the transform (e.g., the FFT) to slices of a difference signal corresponding to a complete (e.g., full) period of a potential flicker cycle can improve the accuracy of the transform (e.g., the FFT) relative to transforming other portions of the difference signal, or the difference signal in its entirety. As such, the slice segmentation circuitry 435 segments difference signals, such as the difference signal 610, into slice(s), such as the example slice 605, the correspond to complete (e.g., full) period of potential flicker cycles, which are then transformed (e.g., using an FFT) by the flicker analysis circuitry 420 to detect the presence of flicker.

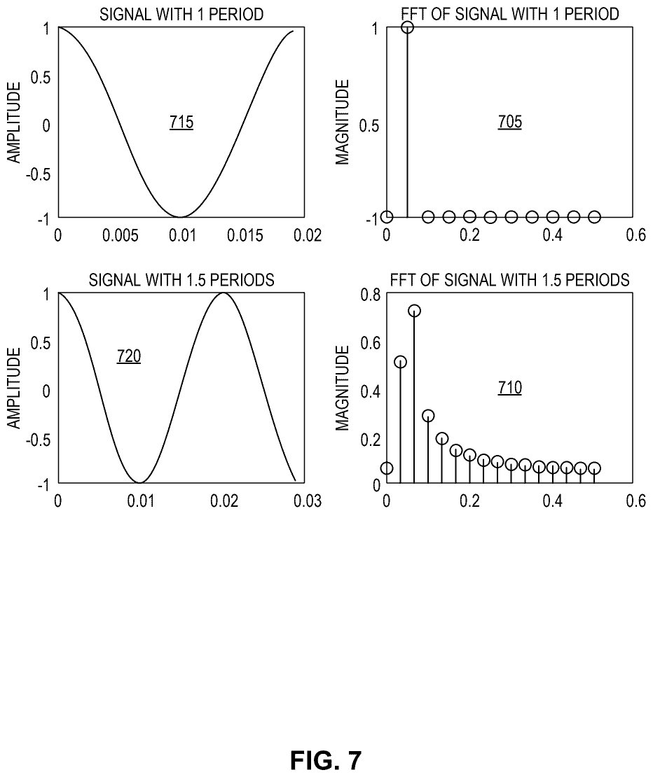

FIG. 7 illustrate different example transformed signals 705 and 710 generated from corresponding different example slices 715 and 720 segmented from the example difference signal 610. The FFT assumes that an input signal is periodic. When transforming a non-integer number of periods, the FFT treats the input signal as if it repeats, which can cause spectral leakage in which energy spreads into adjacent frequencies. Thus, for accurate frequency analysis, the input signal should have one period that fits within the FFT sampling window. Otherwise, the FFT incorrectly assumes the signal extends beyond the window, introducing errors and distorting the frequency components.

FIG. 7 illustrates a first slice 715 corresponding to a single period extracted from the difference signal 610. FIG. 7 also illustrates a second slice 720 corresponding to 1.5 periods extracted from the difference signal 610. The FFT of the first slice 715 yields the transform 705, which includes a dominant component at the frequency of the first slice 715 and no spectral leakage. In contrast, the FFT of the second slice 720 yields the transform 710, which exhibits spectral leakage in which energy spreads across adjacent frequencies.

Returning to FIG. 4, the frequency analysis circuitry 440 of the flicker analysis circuitry 420 performs a frequency analysis on the slice(s) obtained by the slice segmentation circuitry 435 to detect flicker represented in a difference signal, such as the difference signal 610, associated with the current image frame 120 being analyzed. In some examples, the frequency analysis circuitry 440 analyzes each slice independently using an FFT to identify dominant frequencies. In some examples, the FFT analysis focuses on finding the dominant frequency within a given slice, allowing for precise classification of sinusoidal patterns. By utilizing full period segmentation and FFT classification, the frequency analysis circuitry 440 can robustly identify sinusoidal patterns, thereby providing precise frequency estimation and enhancing the reliability of flicker detection.

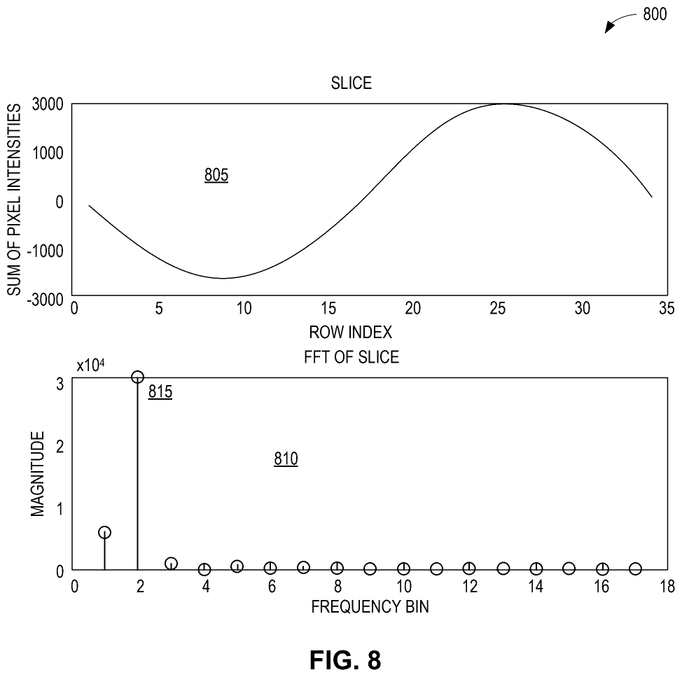

For example, FIG. 8 illustrates an example frequency analysis 800 performed by the frequency analysis circuitry 440 on an example slice 805 of a difference signal. The slice 805 of the illustrated example corresponds to a complete (e.g., full) period of a potential flicker cycle. The frequency analysis circuitry 440 transforms the slice 805 using an FFT to generate an example transformed signal 810. The frequency analysis circuitry 440 then identifies a dominant component of the transformed signal 810. For example, the frequency analysis circuitry 440 computes the magnitude of the transformed signal 810 and identifies the dominant component of the transformed signal 810 as the frequency component having the largest magnitude. In the illustrated example, the frequency analysis circuitry 440 identifies the example frequency component 815 as the dominant frequency component of the transformed signal 810.

The frequency analysis circuitry 440 then uses the dominant frequency component 815 of the transformed signal 810 to determine whether flicker is present in the slice 805. For example, the frequency analysis circuitry 440 compares the dominant frequency component 815 to a threshold to determine whether flicker is present in the slice 805. (In some examples, this threshold is configurable and one of the selection metrics initialized at operation 1 of the example frame selection process shown in Table 1.) In some examples, the frequency analysis circuitry 440 detects flicker in the slice 805 if the dominant frequency component 815 has a magnitude that satisfies (e.g., meets or exceeds) the threshold, and determines flicker is not present if the magnitude of the dominant frequency component 815 does not satisfy (e.g., is less than) the threshold. In some examples, if the frequency analysis circuitry 440 detects that flicker is present in the slice 805, the frequency analysis circuitry 440 also identifies the frequency of the dominant frequency component 815 as the frequency of the flicker detected in the slice 805.

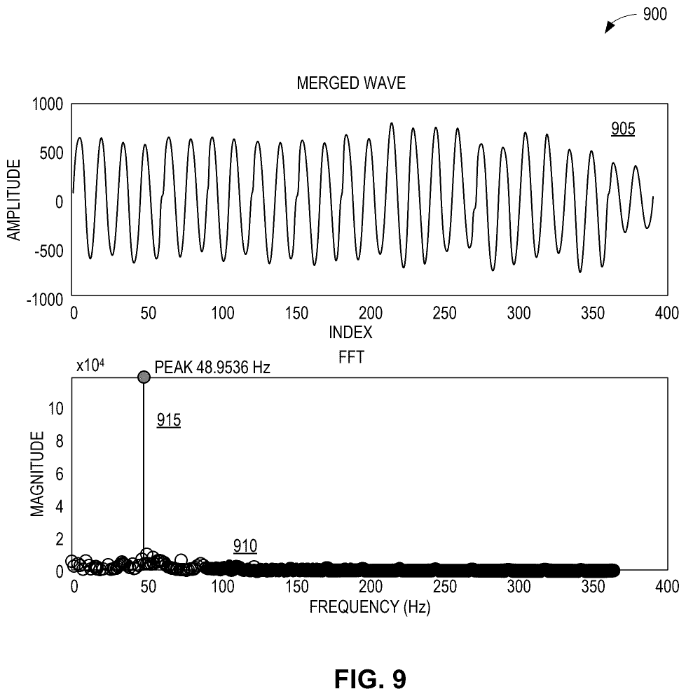

In some examples, the frequency analysis circuitry 440 obtains slices from difference signals determined for the current image frame, as described above, and determined for one or more subsequent image frames using the procedures described above. As described above, each slice represents one complete period of a potential flicker cycle associated with its respective image frame. The frequency analysis circuitry 440 then merges the slices associated with the multiple image frames (e.g., a sequence of image frames including the current image frame and one or more subsequent image frames) to determine a merged signal associated with the multiple image frames. In some examples, the frequency analysis circuitry 440 forms the merged signal by concatenating the slices associated with the multiple image frames to determine a concatenated signal associated with the multiple image frames. This approach allows for a comprehensive analysis of the flicker effect by leveraging temporal variations captured across a sequence of multiple frames. An example merged/concatenated signal 905 formed by the frequency analysis circuitry 440 from slices segmented from difference signals corresponding to multiple adjacent image frames is illustrated in FIG. 9

To facilitate such slice merging/concatenation, in some examples, the slice segmentation circuitry 435 stores the slice(s) segmented from difference signals associated with analyzed image frames in the slice storage 445. The slice storage 445 can be implemented by any numbers and/or types of storage devices, memories, etc. For example, the slice storage 445 can be implemented by one or more of the local memory 1313, the volatile memory 1314, the non-volatile memory 1316, and/or the mass storage discs or devices 1328 described in further detail below.

After a target number of slices associated with a sequence of one or more analyzed images frames are stored in the slice storage 445, the frequency analysis circuitry 440 retrieves the slices from the slice storage 455 and merges/concatenates the retrieved slices to form a single, continuous merged/concatenated signal. In some examples, the target number of slices is configurable and one of the selection metrics initialized at operation 1 of the frame selection process shown in Table 1. The frequency analysis circuitry 440 then transforms the merged/concatenated signal (e.g., using the FFT) to determine a transformed merged/concatenated signal. FIG. 9 illustrates an example transformed merged/concatenated signal 910 formed by the frequency analysis circuitry 440 from the merged/concatenated signal 905.

The frequency analysis circuitry 440 can then analyze this transformed merged/concatenated signal to detect flicker associated with the sequence of analyzed image frames represented in the merged/concatenated signal. For example, the frequency analysis circuitry 440 may identify the dominant component of the transformed merged/concatenated signal, determine whether flicker is present based on comparison of the magnitude of the dominance component to a threshold, and output an indication that flicker has been detected, as well as the estimated frequency of the flicker, if the magnitude of the dominance component satisfies the threshold. In the illustrated example of FIG. 9, the frequency analysis circuitry 440 identifies an example dominant component 915 in the transformed merged/concatenated signal 910. By concatenating enough slices, the frequency resolution in the transform domain becomes small enough to precisely identify the flicker's frequency. For example, the number of slices can be configured to ensure that the frequency resolution Δf is fine enough to distinguish between close frequencies, such as 50 Hz and 60 Hz, which requires Δf to be at most 10 Hz. The number of samples in the merged/concatenated signal determines the frequency resolution, allowing for precise frequency detection and reliable flicker identification across varying lighting conditions.

Returning to FIG. 4, the frequency analysis circuitry 440 provides an example flicker detection output 450. For example, if the frequency analysis circuitry 440 detects the presence of flicker in the difference signal slice(s) analyzed for the current image frame 120, the frequency analysis circuitry 440 indicates/reports (e.g., based on a value, an instruction, a message, etc.) in the flicker detection output 450 that flicker has been detected in the current image frame 120. In some such examples, the frequency analysis circuitry 440 also indicates/reports (e.g., based on a value, an instruction, a message, etc.) in the flicker detection output 450 the detected frequency of the flicker (e.g., as the frequency corresponding to the dominant component of the transformed signal determined from the slice(s) analyzed for the current image frame 120).

In some examples, the flicker detection circuitry 105 of the illustrated example includes the camera control circuitry 425 to control operation of the camera 115 based on the flicker detection output 450 provided by the flicker analysis circuitry 420 and, more specifically, by the frequency analysis circuitry 440 of the flicker analysis circuitry 420. As described above, flicker in camera imagery can be caused by periodic brightness fluctuations in artificial lighting powered by AC sources, such as fluorescent lights, LED lights, etc. To reduce flicker, the camera control circuitry 425 can adjust the camera's exposure time to match the flicker frequency identified in the flicker detection output 450, or an integer multiple of that flicker frequency. For example, the camera control circuitry 425 may adjust the camera's exposure time using multiples of 10 milliseconds (ms) for 50 Hz environments and multiples of 8.333 ms for 60 Hz, ensuring each camera image frame integrates a consistent amount of light, thereby reducing visible flicker artifacts.

In summary, in some examples, the flicker detection circuitry 105 of FIGS. 1 and/or 4 implements detects flicker in camera imagery as follows. The image access circuitry 405 of the flicker detection circuitry 105 accesses a first image (e.g., a current image) of a sequence of images 120 from the camera 115, as described above. The image selection circuitry 415 of the flicker detection circuitry 105 also selects a second image (e.g., a previous image) of the sequence of images 120 relative to the first image (e.g., the current image) based on an expected flicker cycle, as described above. The flicker analysis circuitry 420 of the flicker detection circuitry 105 then generates a flicker detection output based on the first image (e.g., the current image) and the second image (e.g., the selected previous image), as described above.

In some examples, to select the second (e.g., previous) image, the image selection circuitry 415 modulates (e.g., scales) a first timestamp associated with the first (e.g., current) image and a second timestamp associated with the second (e.g., previous) image based on a frame period (or duration) of the sequence of images 120 to determine a first modulation timestamp associated with the first (e.g., current) image and a second modulation timestamp associated with the second (e.g., previous) image. In some such examples, the image selection circuitry 415 then selects the second image based on comparison of (i) a difference between the second modulation timestamp and the first modulation timestamp to (ii) a midpoint value of the expected flicker cycle, as described above. Equivalently, in some examples, to select the second (e.g., previous) image, the image selection circuitry 415 computes a timestamp difference (or offset) between the first timestamp associated with the first (e.g., current) image and the second timestamp associated, and scales this timestamp difference (or offset) by the period (or duration) of the sequence of images 120 to determine the time difference between the first (e.g., current) image and the second (e.g., previous) image. In some such examples, the image selection circuitry 415 then selects the second image based on comparison of (i) the time difference between the first (e.g., current) image and the second (e.g., previous) image to (ii) a midpoint value of the expected flicker cycle, as described above

Furthermore, in some such examples, the difference between the second modulation timestamp and the first modulation timestamp is a first difference, and image selection circuitry 415 compares the first difference and a second difference to the midpoint value of the expected flicker cycle. For example, the second difference may be between a third modulation timestamp and the first modulation timestamp, the third modulation timestamp associated with a third image of the sequence of images. In some such examples, the image selection circuitry 415 selects the second image and not the third image based on the first difference being closer to the midpoint value of the expected flicker cycle than the second difference, as described above.

Also, in some such examples, the expected flicker cycle is a first expected flicker cycle, and image selection circuitry 415 selects the second (e.g., previous) image based on the first expected flicker cycle and a second expected flicker cycle different from the first expected flicker cycle. For example, the first expected flicker cycle may be 50 Hz, and the second expected flicker cycle may be 60 Hz. In some such examples, the image selection circuitry 415 modulates (e.g., scales) a first timestamp associated with the first (e.g., current) image and a second timestamp associated with the second (e.g., previous) image based on a frame period (or duration) of the sequence of images to determine a first modulation timestamp associated with the first image and a second modulation timestamp associated with the second image, as described above. The image selection circuitry 415 then computes a difference between the second modulation timestamp and the first modulation timestamp, and selects the second image based on comparison of the difference to (i) a midpoint value of the first expected flicker cycle and (ii) a midpoint value of the second expected flicker cycle.

In some examples, the difference signal generation circuitry 430 of the flicker analysis circuitry 420 computes a difference image based on the first (e.g., current) image and the second (e.g., selected previous) image, as described above. The difference signal generation circuitry 430 then sum difference pixel values across respective rows of the difference image to determine a difference signal, as described above 1. The slice segmentation circuitry 435 of the flicker analysis circuitry 420 further segments the difference signal into at least one slice based on zero crossings of the difference signal, as described above. For example, the slice segmentation circuitry 435 may require that the difference signal cross zero at least three (3) times to detect and segment and generate a slice corresponding to that segment. The frequency analysis circuitry 440 of the flicker analysis circuitry 420 then generates the flicker detection output 450 based on the at least one slice, as described above.

In some such examples, the difference signal generation circuitry 430 scale pixel values of the second (e.g., selected previous) image based on an exposure ratio to determine scaled pixel values of the second (e.g., selected previous) image. In some such examples, the difference signal generation circuitry 430 subtracts ones of the scaled pixel values of the second (e.g., selected previous) image from corresponding ones of the pixel values of the first (e.g., current) image to compute the difference pixel values of the difference image.

In some such examples, the slice segmentation circuitry 435 detects three adjacent zero crossings of the difference signal, as described above. In some such examples, the slice segmentation circuitry 435 then segments the difference signal into a first slice based on the three adjacent zero crossings such that the first slice corresponds to a portion of the difference signal including the three adjacent zero crossings, as described above. In some such examples, the frequency analysis circuitry 440 generates a frequency domain signal based on the at least one slice, and generates the flicker detection output 150 based on the frequency domain signal, as described above. For example, the frequency analysis circuitry 440 may identify a dominant frequency of the frequency domain signal, and generate the flicker detection output 450 based on comparison of a magnitude of the dominant frequency to a threshold, as described above. For example, the frequency analysis circuitry 440 may generate the flicker detection output to indicate flicker is present based on the magnitude of the dominant frequency satisfying the threshold, and may generate the flicker detection output to indicate flicker is not present based on the magnitude of the dominant frequency not satisfying the threshold.

In some examples, the frequency analysis circuitry 440 merges (e.g., concatenates) the first slice and a second slice to determine a merged (e.g., concatenated) signal, and transforms the merged (e.g., concatenated) signal to generate the frequency domain signal, as described above. For example, the difference signal generation circuitry 430 may compute a second difference image based on a third image to be analyzed for flicker and a fourth image preceding the third image, the third image subsequent to (e.g., a next adjacent image relative to) the first (e.g., current) image. The difference signal generation circuitry 430 may also sum pixel values across respective rows of the second difference image to determine a second difference signal. The slice segmentation circuitry 435 may then segment the second slice from the second difference signal.

In some examples, the camera control circuitry 425 of the flicker detection circuitry 105 operates to control an exposure setting of the camera 115 based on the flicker detection output 450 of the flicker analysis circuitry 420, as described above.

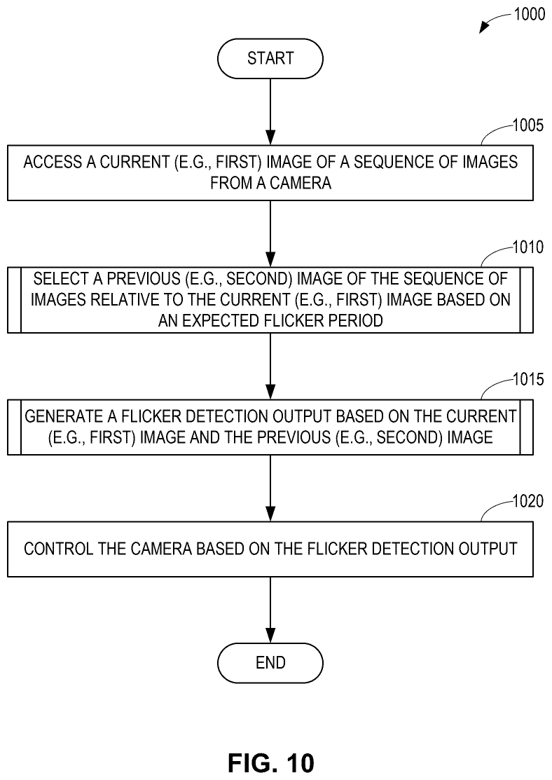

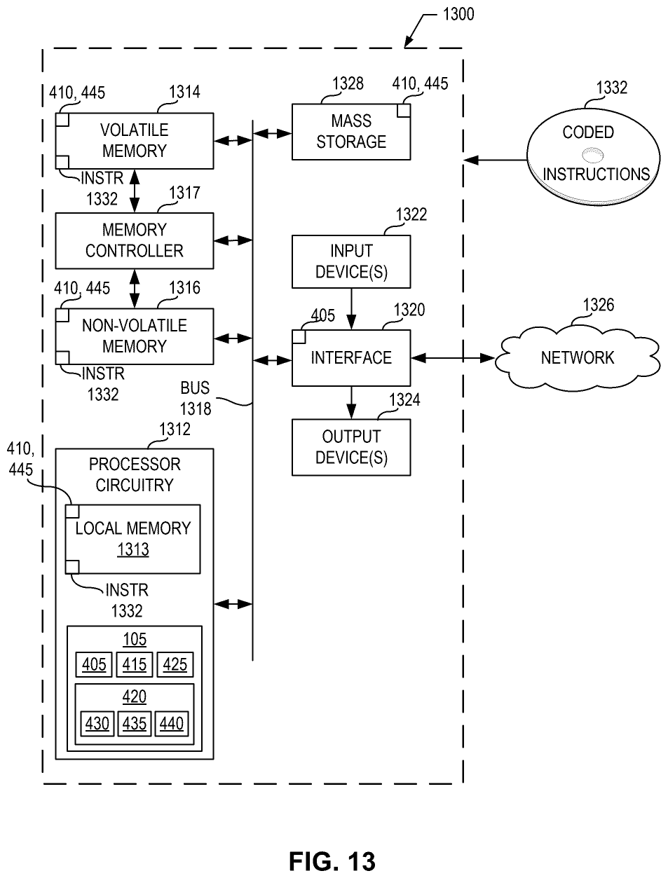

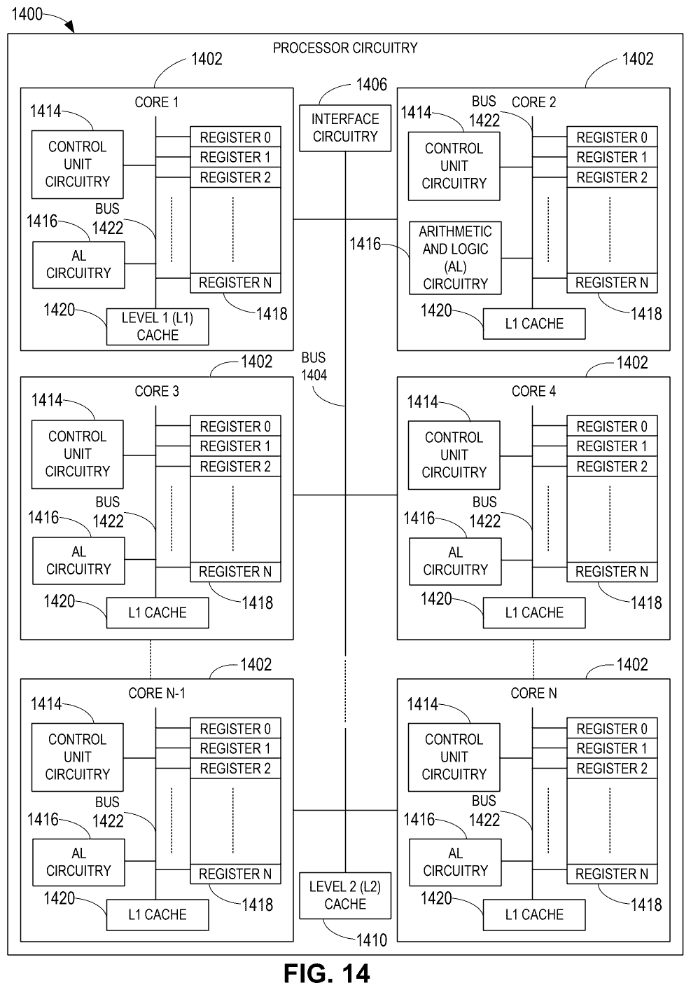

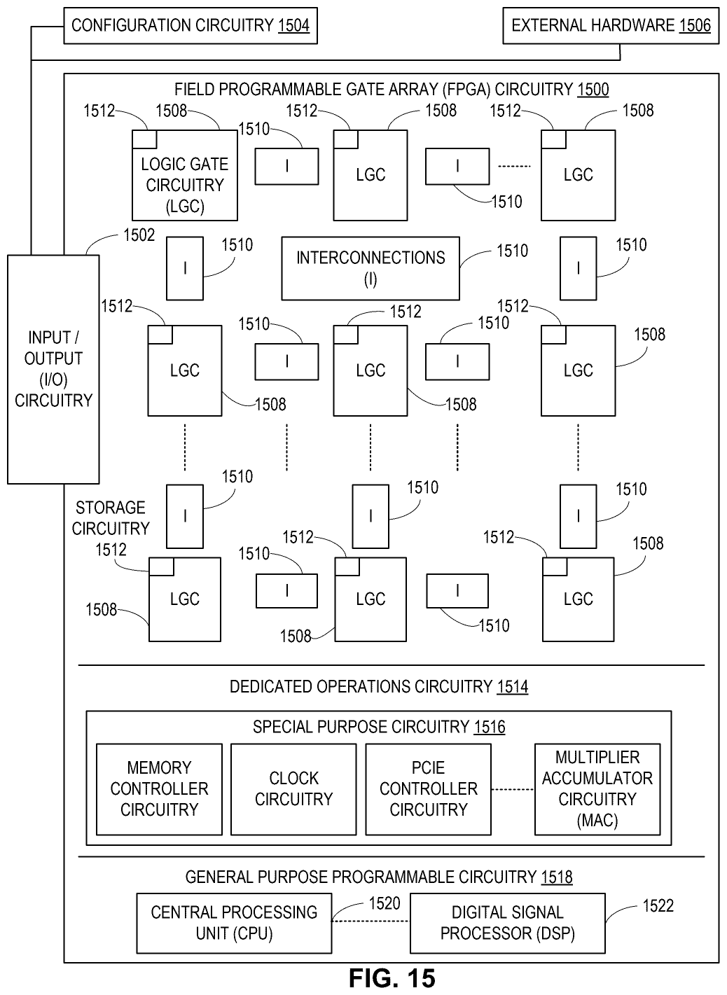

In some examples, the flicker detection circuitry 105 includes means for accessing image data. For example, the means for accessing image data may be implemented by the image access circuitry 405. In some examples, the image access circuitry 405 may be instantiated by programmable circuitry such as the example programmable circuitry 1312 of FIG. 13. For instance, the image access circuitry 405 may be instantiated by the example microprocessor 1400 of FIG. 14 executing machine executable instructions such as those implemented by at least block 1005 of FIG. 10. In some examples, the image access circuitry 405 may be instantiated by hardware logic circuitry, which may be implemented by an ASIC, XPU, or the FPGA circuitry 1500 of FIG. 15 configured and/or structured to perform operations corresponding to the machine-readable instructions. Additionally or alternatively, the image access circuitry 405 may be instantiated by any other combination of hardware, software, and/or firmware. For example, the image access circuitry 405 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

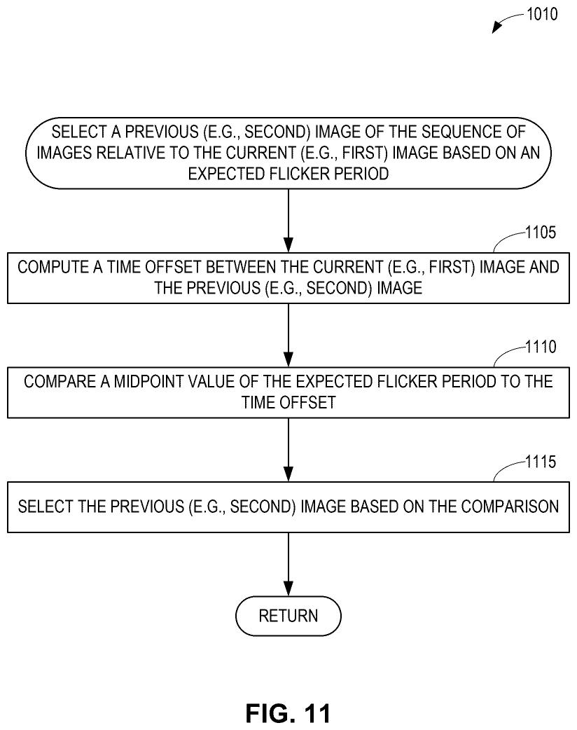

In some examples, the flicker detection circuitry 105 includes means for selecting images. For example, the means for accessing image data may be implemented by the image selection circuitry 415. In some examples, the image selection circuitry 415 may be instantiated by programmable circuitry such as the example programmable circuitry 1312 of FIG. 13. For instance, the image selection circuitry 415 may be instantiated by the example microprocessor 1400 of FIG. 14 executing machine executable instructions such as those implemented by at least block 1010 of FIG. 10 and/or blocks 1105-1115 of FIG. 11. In some examples, the image selection circuitry 415 may be instantiated by hardware logic circuitry, which may be implemented by an ASIC, XPU, or the FPGA circuitry 1500 of FIG. 15 configured and/or structured to perform operations corresponding to the machine-readable instructions. Additionally or alternatively, the image selection circuitry 415 may be instantiated by any other combination of hardware, software, and/or firmware. For example, the image selection circuitry 415 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

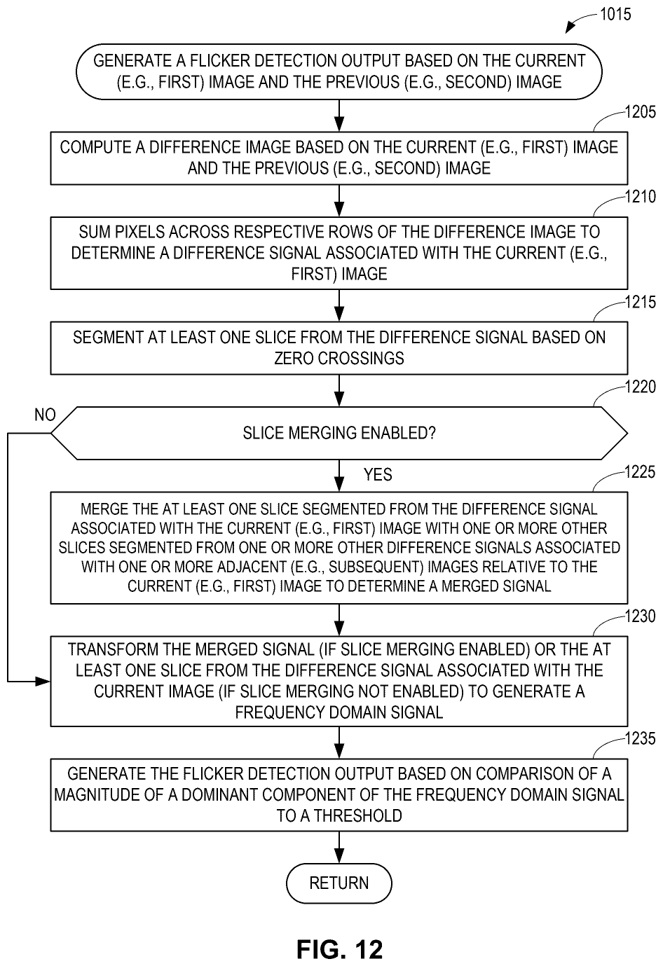

In some examples, the flicker detection circuitry 105 includes means for performing flicker analysis. For example, the means for performing flicker analysis may be implemented by the flicker analysis circuitry 420. In some examples, the flicker analysis circuitry 420 may be instantiated by programmable circuitry such as the example programmable circuitry 1312 of FIG. 13. For instance, the flicker analysis circuitry 420 may be instantiated by the example microprocessor 1400 of FIG. 14 executing machine executable instructions such as those implemented by at least block 1015 of FIG. 10 and/or blocks 1205-1235 of FIG. 12. In some examples, the flicker analysis circuitry 420 may be instantiated by hardware logic circuitry, which may be implemented by an ASIC, XPU, or the FPGA circuitry 1500 of FIG. 15 configured and/or structured to perform operations corresponding to the machine-readable instructions. Additionally or alternatively, the flicker analysis circuitry 420 may be instantiated by any other combination of hardware, software, and/or firmware. For example, the flicker analysis circuitry 420 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the flicker detection circuitry 105 includes means for controlling a camera. For example, the means for controlling a camera may be implemented by the camera control circuitry 425. In some examples, the camera control circuitry 425 may be instantiated by programmable circuitry such as the example programmable circuitry 1312 of FIG. 13. For instance, the camera control circuitry 425 may be instantiated by the example microprocessor 1400 of FIG. 14 executing machine executable instructions such as those implemented by at least block 1020 of FIG. 10. In some examples, the camera control circuitry 425 may be instantiated by hardware logic circuitry, which may be implemented by an ASIC, XPU, or the FPGA circuitry 1500 of FIG. 15 configured and/or structured to perform operations corresponding to the machine-readable instructions. Additionally or alternatively, the camera control circuitry 425 may be instantiated by any other combination of hardware, software, and/or firmware. For example, the camera control circuitry 425 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the flicker analysis circuitry 420 includes means for generating difference signals. For example, the means for generating difference signals may be implemented by the difference signal generation circuitry 430. In some examples, the difference signal generation circuitry 430 may be instantiated by programmable circuitry such as the example programmable circuitry 1312 of FIG. 13. For instance, the difference signal generation circuitry 430 may be instantiated by the example microprocessor 1400 of FIG. 14 executing machine executable instructions such as those implemented by at least blocks 1205-1210 of FIG. 12. In some examples, the difference signal generation circuitry 430 may be instantiated by hardware logic circuitry, which may be implemented by an ASIC, XPU, or the FPGA circuitry 1500 of FIG. 15 configured and/or structured to perform operations corresponding to the machine-readable instructions. Additionally or alternatively, the difference signal generation circuitry 430 may be instantiated by any other combination of hardware, software, and/or firmware. For example, the difference signal generation circuitry 430 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the flicker analysis circuitry 420 includes means for segmenting slices from difference signals. For example, the means for segmenting slices from difference signals may be implemented by the slice segmentation circuitry 435. In some examples, the slice segmentation circuitry 435 may be instantiated by programmable circuitry such as the example programmable circuitry 1312 of FIG. 13. For instance, the slice segmentation circuitry 435 may be instantiated by the example microprocessor 1400 of FIG. 14 executing machine executable instructions such as those implemented by at least block 1215 of FIG. 12. In some examples, the slice segmentation circuitry 435 may be instantiated by hardware logic circuitry, which may be implemented by an ASIC, XPU, or the FPGA circuitry 1500 of FIG. 15 configured and/or structured to perform operations corresponding to the machine-readable instructions. Additionally or alternatively, the slice segmentation circuitry 435 may be instantiated by any other combination of hardware, software, and/or firmware. For example, the slice segmentation circuitry 435 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the flicker analysis circuitry 420 includes means for performing frequency analysis. For example, the means for performing frequency analysis may be implemented by the frequency analysis circuitry 440. In some examples, the frequency analysis circuitry 440 may be instantiated by programmable circuitry such as the example programmable circuitry 1312 of FIG. 13. For instance, the frequency analysis circuitry 440 may be instantiated by the example microprocessor 1400 of FIG. 14 executing machine executable instructions such as those implemented by at least blocks 1220-1235 of FIG. 12. In some examples, the frequency analysis circuitry 440 may be instantiated by hardware logic circuitry, which may be implemented by an ASIC, XPU, or the FPGA circuitry 1500 of FIG. 15 configured and/or structured to perform operations corresponding to the machine-readable instructions. Additionally or alternatively, the frequency analysis circuitry 440 may be instantiated by any other combination of hardware, software, and/or firmware. For example, the frequency analysis circuitry 440 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

While an example manner of implementing the flicker detection circuitry 105 of FIG. 1 is illustrated in FIG. 4, one or more of the elements, processes, and/or devices illustrated in FIG. 4 may be combined, divided, re-arranged, omitted, eliminated, and/or implemented in any other way. Further, the example image access circuitry 405, the example image storage 410, the example image selection circuitry 415, the example flicker analysis circuitry 420, the example camera control circuitry 425, the example difference signal generation circuitry 430, the example slice segmentation circuitry 435, the example frequency analysis circuitry 440, the example slice storage 445 and/or, more generally, the example flicker detection circuitry 105 of FIG. 4, may be implemented by hardware alone or by hardware in combination with software and/or firmware. Thus, for example, any of the example image access circuitry 405, the example image storage 410, the example image selection circuitry 415, the example flicker analysis circuitry 420, the example camera control circuitry 425, the example difference signal generation circuitry 430, the example slice segmentation circuitry 435, the example frequency analysis circuitry 440, the example slice storage 445, and/or, more generally, the example flicker detection circuitry 105, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine-readable instructions (e.g., firmware or software). Further still, the example flicker detection circuitry 105 of FIG. 4 may include one or more elements, processes, and/or devices in addition to, or instead of, those illustrated in FIG. 4, and/or may include more than one of any or all of the illustrated elements, processes and devices.

Flowchart(s) representative of example machine-readable instructions, which may be executed by programmable circuitry to implement and/or instantiate the flicker detection circuitry 105 of FIG. 4 and/or representative of example operations which may be performed by programmable circuitry to implement and/or instantiate the flicker detection circuitry 105 of FIG. 4, are shown in FIGS. 10-12. The machine-readable instructions may be one or more executable programs or portion(s) of one or more executable programs for execution by programmable circuitry such as the programmable circuitry 1312 shown in the example processor platform 1300 discussed below in connection with FIG. 13 and/or may be one or more function(s) or portion(s) of functions to be performed by the example programmable circuitry (e.g., an FPGA) discussed below in connection with FIGS. 14 and/or 15. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart(s) illustrated in FIGS. 10-12, many other methods of implementing the example flicker detection circuitry 105 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 10-12 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 10 is a flowchart representative of example machine-readable instructions and/or example operations 1000 that may be executed, instantiated, and/or performed by programmable circuitry to implement the flicker detection circuitry 105 of FIGS. 1 and/or 4. The example machine-readable instructions and/or the example operations 1000 of FIG. 10 begin at block 1005, at which the image access circuitry 405 of the flicker detection circuitry 105 accesses a current (e.g., first) image of a sequence of images 120 from the camera 115, as described above. At block 1010, the image selection circuitry 415 of the flicker detection circuitry 105 selects a previous (e.g., second) image of the sequence of images relative to the current (e.g., first) image based on an expected flicker period, as described above. At block 1015, the flicker analysis circuitry 420 of the flicker detection circuitry 105 generates the flicker detection output 450 based on the current (e.g., first) image and the previous (e.g., second image), as described above. At block 1020, the camera control circuitry 425 of the flicker detection circuitry 105 controls the camera 115 based on the flicker detection output 450, as described above. The example machine-readable instructions and/or the example operations 1000 then end.

FIG. 11 is a flowchart representative of example machine-readable instructions and/or example operations 1010 that may be executed, instantiated, and/or performed by programmable circuitry to implement the image selection circuitry 415 and/or the processing at block 1010 of FIG. 10. The example machine-readable instructions and/or the example operations 1010 of FIG. 11 begin at block 1105, at which the image selection circuitry 415 computes a time offset between the current (e.g., first) image and the previous (e.g., second) image, as described above. At block 1110, the image selection circuitry 415 compares a midpoint value of the expected flicker period to the time offset, as described above. At block 1115, the image selection circuitry 415 select the previous (e.g., second) image based on the comparison, as described above. The example machine-readable instructions and/or the example operations 1010 then end.

FIG. 12 is a flowchart representative of example machine-readable instructions and/or example operations 1010 that may be executed, instantiated, and/or performed by programmable circuitry to implement the flicker analysis circuitry 420 and/or the processing at block 1015 of FIG. 10. The example machine-readable instructions and/or the example operations 1015 of FIG. 12 begin at block 1205, at which the difference signal generation circuitry 430 of the flicker analysis circuitry 420 computes a difference image based on the current (e.g., first) image and the previous (e.g., second image), as described above. At block 1210, the difference signal generation circuitry 430 sums pixels across respective rows of the difference image to determine a difference signal associated with the current (e.g., first) image, as described above. At block 1215, the slice segmentation circuitry 435 of the flicker analysis circuitry 420 segments at least one slice from the difference signal based on zero crossings, as described above.

At block 1220, the frequency analysis circuitry 440 of the flicker analysis circuitry 420 determines whether slice merging (e.g., slice concatenation), as described above, is enabled. If slice merging is enabled (corresponding to the “YES” output from block 1220), then at block 1225 the frequency analysis circuitry 440 merges the at least one slice segmented from the difference signal associated with the current (e.g., first) image with one or more other slices segmented from one or more other difference signals associated with one or more adjacent (e.g., prior) images relative to the current (e.g., first) image to determine a merged signal (e.g., a concatenated signal), as described above.

At block 1230, the frequency analysis circuitry 440 transforms the merged (e.g., concatenated) signal (if slice merging is enabled) or the at least one slice from the difference signal associated with the current image (if slice merging not enabled) to generate a transformed signal, such as a frequency domain signal, as described above. At block 1235, the frequency analysis circuitry 440 generates the flicker detection output based on comparison of a magnitude of a dominant component of the frequency domain signal to a threshold, as described above.

FIG. 13 is a block diagram of an example programmable circuitry platform 1300 structured to execute and/or instantiate the example machine-readable instructions and/or the example operations of FIGS. 10-12 to implement the flicker detection circuitry 105 of FIG. 4. The programmable circuitry platform 1300 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1300 of the illustrated example includes programmable circuitry 1312. The programmable circuitry 1312 of the illustrated example is hardware. For example, the programmable circuitry 1312 can be implemented by one or more integrated circuits, logic circuits, FPGAs, microprocessors, CPUs, GPUs, VPUs, DSPs, and/or microcontrollers from any desired family or manufacturer. The programmable circuitry 1312 may be implemented by one or more semiconductor based (e.g., silicon based) devices. In this example, the programmable circuitry 1312 implements the example image access circuitry 405, the example image selection circuitry 415, the example flicker analysis circuitry 420, the example camera control circuitry 425, the example difference signal generation circuitry 430, the example slice segmentation circuitry 435 and/or the example frequency analysis circuitry 440 of the flicker detection circuitry 105.

The programmable circuitry 1312 of the illustrated example includes a local memory 1313 (e.g., a cache, registers, etc.). The programmable circuitry 1312 of the illustrated example is in communication with main memory 1314, 1316, which includes a volatile memory 1314 and a non-volatile memory 1316, by a bus 1318. The volatile memory 1314 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1316 may be implemented by flash memory and/or any other desired type of memory device. Access to the main memory 1314, 1316 of the illustrated example is controlled by a memory controller 1317. In some examples, the memory controller 1317 may be implemented by one or more integrated circuits, logic circuits, microcontrollers from any desired family or manufacturer, or any other type of circuitry to manage the flow of data going to and from the main memory 1314, 1316. In some examples, the local memory 1313, the volatile memory 1314 and/or the non-volatile memory 1316 implement the example image storage 410 and/or the example slice storage 445 of the flicker detection circuitry 105.

The programmable circuitry platform 1300 of the illustrated example also includes interface circuitry 1320. The interface circuitry 1320 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In some examples, the interface circuitry 1320 implements the image access circuitry 405 of the flicker detection circuitry 105.

In the illustrated example, one or more input devices 1322 are connected to the interface circuitry 1320. The input device(s) 1322 permit(s) a user (e.g., a human user, a machine user, etc.) to enter data and/or commands into the programmable circuitry 1312. The input device(s) 1322 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1324 are also connected to the interface circuitry 1320 of the illustrated example. The output device(s) 1324 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1320 of the illustrated example, thus, typically includes a graphics driver card, a graphics driver chip, and/or graphics processor circuitry such as a GPU.

The interface circuitry 1320 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1326. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1300 of the illustrated example also includes one or more mass storage discs or devices 1328 to store firmware, software, and/or data. Examples of such mass storage discs or devices 1328 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs. In some examples, the one or more mass storage discs or devices 1328 implement the example image storage 410 and/or the example slice storage 445 of the flicker detection circuitry 105.

The machine-readable instructions 1332, which may be implemented by the machine-readable instructions of FIGS. 10-12, may be stored in the mass storage device 1328, in the volatile memory 1314, in the non-volatile memory 1316, and/or on at least one non-transitory computer-readable storage medium such as a CD or DVD which may be removable.

FIG. 14 is a block diagram of an example implementation of the programmable circuitry 1312 of FIG. 13. In this example, the programmable circuitry 1312 of FIG. 13 is implemented by a microprocessor 1400. For example, the microprocessor 1400 may be a general-purpose microprocessor (e.g., general-purpose microprocessor circuitry). The microprocessor 1400 executes some or all of the machine-readable instructions of the flowcharts of FIGS. 10-12 to effectively instantiate the circuitry of FIG. 4 as logic circuits to perform operations corresponding to those machine-readable instructions. In some such examples, the circuitry of FIG. 4 is instantiated by the hardware circuits of the microprocessor 1400 in combination with the machine-readable instructions. For example, the microprocessor 1400 may be implemented by multi-core hardware circuitry such as a CPU, a DSP, a GPU, an XPU, etc. Although it may include any number of example cores 1402 (e.g., 1 core), the microprocessor 1400 of this example is a multi-core semiconductor device including N cores. The cores 1402 of the microprocessor 1400 may operate independently or may cooperate to execute machine-readable instructions. For example, machine code corresponding to a firmware program, an embedded software program, or a software program may be executed by one of the cores 1402 or may be executed by multiple ones of the cores 1402 at the same or different times. In some examples, the machine code corresponding to the firmware program, the embedded software program, or the software program is split into threads and executed in parallel by two or more of the cores 1402. The software program may correspond to a portion or all of the machine-readable instructions and/or operations represented by the flowcharts of FIGS. 10-12.

The cores 1402 may communicate by a first example bus 1404. In some examples, the first bus 1404 may be implemented by a communication bus to effectuate communication associated with one(s) of the cores 1402. For example, the first bus 1404 may be implemented by at least one of an Inter-Integrated Circuit (I2C) bus, a Serial Peripheral Interface (SPI) bus, a PCI bus, or a PCIe bus. Additionally or alternatively, the first bus 1404 may be implemented by any other type of computing or electrical bus. The cores 1402 may obtain data, instructions, and/or signals from one or more external devices by example interface circuitry 1406. The cores 1402 may output data, instructions, and/or signals to the one or more external devices by the interface circuitry 1406. Although the cores 1402 of this example include example local memory 1420 (e.g., Level 1 (L1) cache that may be split into an L1 data cache and an L1 instruction cache), the microprocessor 1400 also includes example shared memory 1410 that may be shared by the cores (e.g., Level 2 (L2 cache)) for high-speed access to data and/or instructions. Data and/or instructions may be transferred (e.g., shared) by writing to and/or reading from the shared memory 1410. The local memory 1420 of each of the cores 1402 and the shared memory 1410 may be part of a hierarchy of storage devices including multiple levels of cache memory and the main memory (e.g., the main memory 1314, 1316 of FIG. 13). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1402 may be referred to as a CPU, DSP, GPU, etc., or any other type of hardware circuitry. Each core 1402 includes control unit circuitry 1414, arithmetic and logic (AL) circuitry (sometimes referred to as an ALU) 1416, a plurality of registers 1418, the local memory 1420, and a second example bus 1422. Other structures may be present. For example, each core 1402 may include vector unit circuitry, single instruction multiple data (SIMD) unit circuitry, load/store unit (LSU) circuitry, branch/jump unit circuitry, floating-point unit (FPU) circuitry, etc. The control unit circuitry 1414 includes semiconductor-based circuits structured to control (e.g., coordinate) data movement within the corresponding core 1402. The AL circuitry 1416 includes semiconductor-based circuits structured to perform one or more mathematic and/or logic operations on the data within the corresponding core 1402. The AL circuitry 1416 of some examples performs integer based operations. In other examples, the AL circuitry 1416 also performs floating-point operations. In yet other examples, the AL circuitry 1416 may include first AL circuitry that performs integer-based operations and second AL circuitry that performs floating-point operations. In some examples, the AL circuitry 1416 may be referred to as an Arithmetic Logic Unit (ALU).

The registers 1418 are semiconductor-based structures to store data and/or instructions such as results of one or more of the operations performed by the AL circuitry 1416 of the corresponding core 1402. For example, the registers 1418 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1418 may be arranged in a bank as shown in FIG. 14. Alternatively, the registers 1418 may be organized in any other arrangement, format, or structure, such as by being distributed throughout the core 1402 to shorten access time. The second bus 1422 may be implemented by at least one of an I2C bus, a SPI bus, a PCI bus, or a PCIe bus.

Each core 1402 and/or, more generally, the microprocessor 1400 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1400 is a semiconductor device fabricated to include many transistors interconnected to implement the structures described above in one or more integrated circuits (ICs) contained in one or more packages.

The microprocessor 1400 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1400, in the same chip package as the microprocessor 1400 and/or in one or more separate packages from the microprocessor 1400.

FIG. 15 is a block diagram of another example implementation of the programmable circuitry 1312 of FIG. 13. In this example, the programmable circuitry 1312 is implemented by FPGA circuitry 1500. For example, the FPGA circuitry 1500 may be implemented by an FPGA. The FPGA circuitry 1500 can be used, for example, to perform operations that could otherwise be performed by the example microprocessor 1400 of FIG. 14 executing corresponding machine-readable instructions. However, once configured, the FPGA circuitry 1500 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1400 of FIG. 14 described above (which is a general purpose device that may be programmed to execute some or all of the machine-readable instructions represented by the flowchart(s) of FIGS. 10-12 but whose interconnections and logic circuitry are fixed once fabricated), the FPGA circuitry 1500 of the example of FIG. 15 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 10-12. In particular, the FPGA circuitry 1500 may be thought of as an array of logic gates, interconnections, and switches. The switches can be programmed to change how the logic gates are interconnected by the interconnections, effectively forming one or more dedicated logic circuits (unless and until the FPGA circuitry 1500 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 10-12. As such, the FPGA circuitry 1500 may be configured and/or structured to effectively instantiate some or all of the operations/functions corresponding to the machine-readable instructions of the flowchart(s) of FIGS. 10-12 as dedicated logic circuits to perform the operations/functions corresponding to those software instructions in a dedicated manner analogous to an ASIC. Therefore, the FPGA circuitry 1500 may perform the operations/functions corresponding to the some or all of the machine-readable instructions of FIGS. 10-12 faster than the general-purpose microprocessor can execute the same.

In the example of FIG. 15, the FPGA circuitry 1500 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1500 of FIG. 15 may access and/or load the binary file to cause the FPGA circuitry 1500 of FIG. 15 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1500 of FIG. 15 to cause configuration and/or structuring of the FPGA circuitry 1500 of FIG. 15, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1500 of FIG. 15 may access and/or load the binary file to cause the FPGA circuitry 1500 of FIG. 15 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1500 of FIG. 15 to cause configuration and/or structuring of the FPGA circuitry 1500 of FIG. 15, or portion(s) thereof.

The FPGA circuitry 1500 of FIG. 15, includes example input/output (I/O) circuitry 1502 to obtain and/or output data to/from example configuration circuitry 1504 and/or external hardware 1506. For example, the configuration circuitry 1504 may be implemented by interface circuitry that may obtain a binary file, which may be implemented by a bit stream, data, and/or machine-readable instructions, to configure the FPGA circuitry 1500, or portion(s) thereof. In some such examples, the configuration circuitry 1504 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1506 may be implemented by external hardware circuitry. For example, the external hardware 1506 may be implemented by the microprocessor 1400 of FIG. 14.

The FPGA circuitry 1500 also includes an array of example logic gate circuitry 1508, a plurality of example configurable interconnections 1510, and example storage circuitry 1512. The logic gate circuitry 1508 and the configurable interconnections 1510 are configurable to instantiate one or more operations/functions that may correspond to at least some of the machine-readable instructions of FIGS. 10-12 and/or other desired operations. The logic gate circuitry 1508 shown in FIG. 15 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1508 to enable configuration of the electrical structures and/or the logic gates to form circuits to perform desired operations/functions. The logic gate circuitry 1508 may include other electrical structures such as look-up tables (LUTs), registers (e.g., flip-flops or latches), multiplexers, etc.

The configurable interconnections 1510 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1508 to program desired logic circuits.

The storage circuitry 1512 of the illustrated example is structured to store result(s) of the one or more of the operations performed by corresponding logic gates. The storage circuitry 1512 may be implemented by registers or the like. In the illustrated example, the storage circuitry 1512 is distributed amongst the logic gate circuitry 1508 to facilitate access and increase execution speed.

The example FPGA circuitry 1500 of FIG. 15 also includes example dedicated operations circuitry 1514. In this example, the dedicated operations circuitry 1514 includes special purpose circuitry 1516 that may be invoked to implement commonly used functions to avoid the need to program those functions in the field. Examples of such special purpose circuitry 1516 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1500 may also include example general purpose programmable circuitry 1518 such as an example CPU 1520 and/or an example DSP 1522. Other general purpose programmable circuitry 1518 may additionally or alternatively be present such as a GPU, an XPU, etc., that can be programmed to perform other operations.

Although FIGS. 14 and 15 illustrate two example implementations of the programmable circuitry 1312 of FIG. 13, many other approaches are contemplated. For example, FPGA circuitry may include an on-board CPU, such as one or more of the example CPU 1520 of FIG. 14. Therefore, the programmable circuitry 1312 of FIG. 13 may additionally be implemented by combining at least the example microprocessor 1400 of FIG. 14 and the example FPGA circuitry 1500 of FIG. 15. In some such hybrid examples, one or more cores 1402 of FIG. 14 may execute a first portion of the machine-readable instructions represented by the flowchart(s) of FIGS. 10-12 to perform first operation(s)/function(s), the FPGA circuitry 1500 of FIG. 15 may be configured and/or structured to perform second operation(s)/function(s) corresponding to a second portion of the machine-readable instructions represented by the flowcharts of FIGS. 10-12, and/or an ASIC may be configured and/or structured to perform third operation(s)/function(s) corresponding to a third portion of the machine-readable instructions represented by the flowcharts of FIGS. 10-12.

It should be understood that some or all of the circuitry of FIG. 4 may, thus, be instantiated at the same or different times. For example, same and/or different portion(s) of the microprocessor 1400 of FIG. 14 may be programmed to execute portion(s) of machine-readable instructions at the same and/or different times. In some examples, same and/or different portion(s) of the FPGA circuitry 1500 of FIG. 15 may be configured and/or structured to perform operations/functions corresponding to portion(s) of machine-readable instructions at the same and/or different times.

In some examples, some or all of the circuitry of FIG. 4 may be instantiated, for example, in one or more threads executing concurrently and/or in series. For example, the microprocessor 1400 of FIG. 14 may execute machine-readable instructions in one or more threads executing concurrently and/or in series. In some examples, the FPGA circuitry 1500 of FIG. 15 may be configured and/or structured to carry out operations/functions concurrently and/or in series. Moreover, in some examples, some or all of the circuitry of FIG. 4 may be implemented within one or more virtual machines and/or containers executing on the microprocessor 1400 of FIG. 14.

In some examples, the programmable circuitry 1312 of FIG. 13 may be in one or more packages. For example, the microprocessor 1400 of FIG. 14 and/or the FPGA circuitry 1500 of FIG. 15 may be in one or more packages. In some examples, an XPU may be implemented by the programmable circuitry 1312 of FIG. 13, which may be in one or more packages. For example, the XPU may include a CPU (e.g., the microprocessor 1400 of FIG. 14, the CPU 1520 of FIG. 15, etc.) in one package, a DSP (e.g., the DSP 1522 of FIG. 15) in another package, a GPU in yet another package, and an FPGA (e.g., the FPGA circuitry 1500 of FIG. 15) in still yet another package.

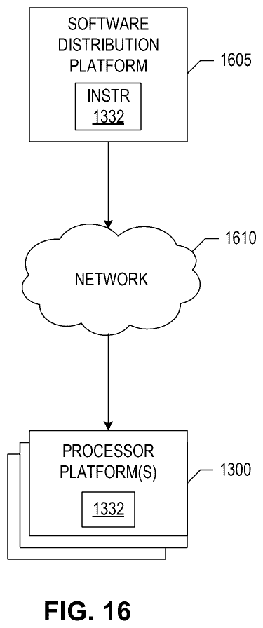

A block diagram illustrating an example software distribution platform 1605 to distribute software such as the example machine-readable instructions 1332 of FIG. 13 to other hardware devices (e.g., hardware devices owned and/or operated by third parties from the owner and/or operator of the software distribution platform) is illustrated in FIG. 16. The example software distribution platform 1605 may be implemented by any computer server, data facility, cloud service, etc., capable of storing and transmitting software to other computing devices. The third parties may be customers of the entity owning and/or operating the software distribution platform 1605. For example, the entity that owns and/or operates the software distribution platform 1605 may be a developer, a seller, and/or a licensor of software such as the example machine-readable instructions 1332 of FIG. 13. The third parties may be consumers, users, retailers, OEMs, etc., who purchase and/or license the software for use and/or re-sale and/or sub-licensing. In the illustrated example, the software distribution platform 1605 includes one or more servers and one or more storage devices. The storage devices store the machine-readable instructions 1332, which may correspond to the example machine-readable instructions of FIGS. 10-12, as described above. The one or more servers of the example software distribution platform 1605 are in communication with an example network 1610, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine-readable instructions 1332 from the software distribution platform 1605. For example, the software, which may correspond to the example machine-readable instructions of FIG. 10-12, may be downloaded to the example programmable circuitry platform 1300, which is to execute the machine-readable instructions 1332 to implement the flicker detection circuitry 105. In some examples, one or more servers of the software distribution platform 1605 periodically offer, transmit, and/or force updates to the software (e.g., the example machine-readable instructions 1332 of FIG. 13) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/of” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that detect flicker in camera imagery. Disclosed systems, apparatus, articles of manufacture, and methods improve the efficiency of using a computing device by providing enhanced frame selection procedures, enhanced difference signal segmentation and/or concatenation procedures, and/or enhanced frequency procedures to provide accurate detection of flicker in images captured by computing device cameras while avoiding false positive detections. Disclosed systems, apparatus, articles of manufacture, and methods provide the ability to control operation of the camera to mitigate the effects of flicker. Disclosed systems, apparatus, articles of manufacture, and methods are accordingly directed to one or more improvement(s) in the operation of a machine such as a computer or other electronic and/or mechanical device.

Further examples and combinations thereof include the following. Example 1 includes an apparatus comprising interface circuitry, machine-readable instructions, and at least one programmable circuit to be programmed based on the machine-readable instructions to access a first image of a sequence of images from a camera, select a second image of the sequence of images relative to the first image based on an expected flicker cycle, and generate a flicker detection output based on the first image and the second image.

Example 2 includes the apparatus of example 1, wherein one or more of the at least one programmable circuit is to scale a first timestamp associated with the first image and a second timestamp associated with the second image based on a frame period of the sequence of images to determine a first modulation timestamp associated with the first image and a second modulation timestamp associated with the second image, and select the second image based on comparison of (i) a difference between the second modulation timestamp and the first modulation timestamp to (ii) a midpoint value of the expected flicker cycle.

Example 3 includes the apparatus of example 2, wherein the difference is a first difference, and one or more of the at least one programmable circuit is to compare the first difference and a second difference to the midpoint value of the expected flicker cycle, the second difference between a third modulation timestamp and the first modulation timestamp, the third modulation timestamp associated with a third image of the sequence of images, and select the second image and not the third image based on the first difference being closer to the midpoint value of the expected flicker cycle than the second difference.

Example 4 includes the apparatus of example 1, wherein the expected flicker cycle is a first expected flicker cycle, and one or more of the at least one programmable circuit is to select the second image based on the first expected flicker cycle and a second expected flicker cycle different from the first expected flicker cycle.

Example 5 includes the apparatus of example 4, wherein one or more of the at least one programmable circuit is to scale a first timestamp associated with the first image and a second timestamp associated with the second image based on a frame period of the sequence of images to determine a first modulation timestamp associated with the first image and a second modulation timestamp associated with the second image, compute a difference between the second modulation timestamp and the first modulation timestamp, and select the second image based on comparison of the difference to (i) a midpoint value of the first expected flicker cycle and (ii) a midpoint value of the second expected flicker cycle.

Example 6 includes the apparatus of any one of examples 1 to 5, wherein one or more of the at least one programmable circuit is to compute a difference image based on the first image and the second image, sum pixel values across respective rows of the difference image to determine a difference signal, segment the difference signal into at least one slice based on zero crossings of the difference signal, and generate the flicker detection output based on the at least one slice.

Example 7 includes the apparatus of example 6, wherein the pixel values are difference pixel values, and one or more of the at least one programmable circuit is to scale second pixel values of the second image based on an exposure ratio to determine scaled second pixel values, and subtract ones of the scaled second pixel values from corresponding ones of first pixel values of the first image to compute the difference pixel values of the difference image.

Example 8 includes the apparatus of example 6, wherein one or more of the at least one programmable circuit is to detect three adjacent zero crossings of the difference signal, and segment the difference signal into a first slice based on the three adjacent zero crossings, the first slice corresponding to a portion of the difference signal including the three adjacent zero crossings.

Example 9 includes the apparatus of example 6, wherein one or more of the at least one programmable circuit is to generate a frequency domain signal based on the at least one slice, and generate the flicker detection output based on the frequency domain signal.

Example 10 includes the apparatus of example 9, wherein one or more of the at least one programmable circuit is to identify a dominant frequency of the frequency domain signal, and generate the flicker detection output based on comparison of a magnitude of the dominant frequency to a threshold.

Example 11 includes the apparatus of example 10, wherein the flicker detection output is to indicate flicker is present based on the magnitude of the dominant frequency satisfying the threshold, and indicate flicker is not present based on the magnitude of the dominant frequency not satisfying the threshold.

Example 12 includes the apparatus of example 9, wherein the at least one slice includes a first slice, and one or more of the at least one programmable circuit is to merge at least the first slice and a second slice to determine a merged signal, and transform the merged signal to generate the frequency domain signal.

Example 13 includes the apparatus of example 12, wherein the difference image is a first difference image, the difference signal is a first difference signal, the first slice is segmented from the first difference signal, and one or more of the at least one programmable circuit is to compute a second difference image based on a third image to be analyzed for flicker and a fourth image preceding the third image, the third image subsequent to the first image, sum pixel values across respective rows of the second difference image to determine a second difference signal, and segment the second slice from the second difference signal.

Example 14 includes the apparatus of any one of examples 1 to 13, wherein one or more of the at least one programmable circuit is to control an exposure setting of the camera based on the flicker detection output.

Example 15 includes at least one non-transitory machine-readable medium comprising instructions to cause at least one programmable circuit to at least access a current image of a sequence of images from a camera, select a previous image of the sequence of images relative to the current image based on comparison of a midpoint value of a flicker period to a time offset between the current image and the previous image, and generate a flicker detection output based on the current image and the previous image.

Example 16 includes the at least one non-transitory machine-readable medium of example 15, wherein the instructions are to cause one or more of the at least one programmable circuit to sum pixel values across respective rows of a difference image to determine a difference signal associated with the current image, the difference image based on the current image and the previous image, segment a slice from the difference signal based on zero crossings of the difference signal, and generate the flicker detection output based on the slice.

Example 17 includes the at least one non-transitory machine-readable medium of example 16, wherein the slice is a first slice, the difference signal is a first difference signal, and the instructions are to cause one or more of the at least one programmable circuit to merge at least the first slice and a second slice to determine a merged signal, the second slice segmented from a second difference signal associated with an adjacent image of the sequence of images relative to the current image, transform the merged signal to generate a frequency domain signal, and generate the flicker detection output based on comparison of a magnitude of a dominant frequency of the frequency domain signal to a threshold.

Example 18 includes a system comprising a camera, means for selecting images from the camera, the means for selecting to select a previous image of a sequence of images relative to a current image of the sequence of images based on comparison of a midpoint value of a flicker period to a time offset between the current image and the previous image, and means for generating a flicker detection output based on the current image and the previous image.

Example 19 includes the system of example 18, wherein the means for generating is to sum pixel values across respective rows of a difference image to determine a difference signal associated with the current image, the difference image based on the current image and the previous image, segment a slice from the difference signal based on zero crossings of the difference signal, and generate the flicker detection output based on the slice.

Example 20 includes the system of example 19, wherein the slice is a first slice, the difference signal is a first difference signal, and the means for generating is to merge at least the first slice and a second slice to determine a merged signal, the second slice segmented from a second difference signal associated with an adjacent image of the sequence of images relative to the current image, transform the merged signal to generate a frequency domain signal, and generate the flicker detection output based on comparison of a magnitude of a dominant frequency of the frequency domain signal to a threshold.

Example 21 includes a method comprising accessing a current image of a sequence of images from a camera, selecting a previous image of the sequence of images relative to the current image based on comparison of a midpoint value of a flicker period to a time offset between the current image and the previous image, and generating a flicker detection output based on the current image and the previous image.

Example 22 includes the method of example 21, including summing pixel values across respective rows of a difference image to determine a difference signal associated with the current image, the difference image based on the current image and the previous image, segmenting a slice from the difference signal based on zero crossings of the difference signal, and generating the flicker detection output based on the slice.

Example 23 includes the method of example 22, wherein the slice is a first slice, the difference signal is a first difference signal, and including merging at least the first slice and a second slice to determine a merged signal, the second slice segmented from a second difference signal associated with an adjacent image of the sequence of images relative to the current image, transforming the merged signal to generate a frequency domain signal, and generating the flicker detection output based on comparison of a magnitude of a dominant frequency of the frequency domain signal to a threshold.

Example 24 includes at least one machine-readable medium comprising machine-readable instructions to cause at least one programmable circuit to perform the method of any one of examples 21 to example 23.

Example 25 includes an apparatus to perform the method of any one of examples 21 to example 23.

Example 26 includes a method performed by any one of the apparatus of examples 1 to example 14.

Example 27 includes at least one machine-readable medium comprising the machine-readable instructions of any one of the apparatus of examples 1 to example 14.

Example 28 includes a method performed by any one of the systems of examples 18 to example 20.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
machine-readable instructions; and
at least one programmable circuit to be programmed based on the machine-readable instructions to:
access a first image of a sequence of images from a camera;
select a second image of the sequence of images relative to the first image based on an expected flicker cycle; and
generate a flicker detection output based on the first image and the second image.

2. The apparatus of claim 1, wherein one or more of the at least one programmable circuit is to:
scale a first timestamp associated with the first image and a second timestamp associated with the second image based on a frame period of the sequence of images to determine a first modulation timestamp associated with the first image and a second modulation timestamp associated with the second image; and
select the second image based on comparison of (i) a difference between the second modulation timestamp and the first modulation timestamp to (ii) a midpoint value of the expected flicker cycle.

3. The apparatus of claim 2, wherein the difference is a first difference, and one or more of the at least one programmable circuit is to:
compare the first difference and a second difference to the midpoint value of the expected flicker cycle, the second difference between a third modulation timestamp and the first modulation timestamp, the third modulation timestamp associated with a third image of the sequence of images; and
select the second image and not the third image based on the first difference being closer to the midpoint value of the expected flicker cycle than the second difference.

4. The apparatus of claim 1, wherein the expected flicker cycle is a first expected flicker cycle, and one or more of the at least one programmable circuit is to select the second image based on the first expected flicker cycle and a second expected flicker cycle different from the first expected flicker cycle.

5. The apparatus of claim 4, wherein one or more of the at least one programmable circuit is to:
scale a first timestamp associated with the first image and a second timestamp associated with the second image based on a frame period of the sequence of images to determine a first modulation timestamp associated with the first image and a second modulation timestamp associated with the second image;
compute a difference between the second modulation timestamp and the first modulation timestamp; and
select the second image based on comparison of the difference to (i) a midpoint value of the first expected flicker cycle and (ii) a midpoint value of the second expected flicker cycle.

6. The apparatus of claim 1, wherein one or more of the at least one programmable circuit is to:
compute a difference image based on the first image and the second image;
sum pixel values across respective rows of the difference image to determine a difference signal;
segment the difference signal into at least one slice based on zero crossings of the difference signal; and
generate the flicker detection output based on the at least one slice.

7. The apparatus of claim 6, wherein the pixel values are difference pixel values, and one or more of the at least one programmable circuit is to:
scale second pixel values of the second image based on an exposure ratio to determine scaled second pixel values; and
subtract ones of the scaled second pixel values from corresponding ones of first pixel values of the first image to compute the difference pixel values of the difference image.

8. The apparatus of claim 6, wherein one or more of the at least one programmable circuit is to:
detect three adjacent zero crossings of the difference signal; and
segment the difference signal into a first slice based on the three adjacent zero crossings, the first slice corresponding to a portion of the difference signal including the three adjacent zero crossings.

9. The apparatus of claim 6, wherein one or more of the at least one programmable circuit is to:
generate a frequency domain signal based on the at least one slice; and
generate the flicker detection output based on the frequency domain signal.

10. The apparatus of claim 9, wherein one or more of the at least one programmable circuit is to:
identify a dominant frequency of the frequency domain signal; and
generate the flicker detection output based on comparison of a magnitude of the dominant frequency to a threshold.

11. The apparatus of claim 10, wherein the flicker detection output is to:
indicate flicker is present based on the magnitude of the dominant frequency satisfying the threshold; and
indicate flicker is not present based on the magnitude of the dominant frequency not satisfying the threshold.

12. The apparatus of claim 9, wherein the at least one slice includes a first slice, and one or more of the at least one programmable circuit is to:
merge at least the first slice and a second slice to determine a merged signal; and
transform the merged signal to generate the frequency domain signal.

13. The apparatus of claim 12, wherein the difference image is a first difference image, the difference signal is a first difference signal, the first slice is segmented from the first difference signal, and one or more of the at least one programmable circuit is to:
compute a second difference image based on a third image to be analyzed for flicker and a fourth image preceding the third image, the third image subsequent to the first image;
sum pixel values across respective rows of the second difference image to determine a second difference signal; and
segment the second slice from the second difference signal.

14. The apparatus of claim 1, wherein one or more of the at least one programmable circuit is to control an exposure setting of the camera based on the flicker detection output.

15. At least one non-transitory machine-readable medium comprising instructions to cause at least one programmable circuit to at least:
access a current image of a sequence of images from a camera;
select a previous image of the sequence of images relative to the current image based on comparison of a midpoint value of a flicker period to a time offset between the current image and the previous image; and
generate a flicker detection output based on the current image and the previous image.

16. The at least one non-transitory machine-readable medium of claim 15, wherein the instructions are to cause one or more of the at least one programmable circuit to:
sum pixel values across respective rows of a difference image to determine a difference signal associated with the current image, the difference image based on the current image and the previous image;
segment a slice from the difference signal based on zero crossings of the difference signal; and
generate the flicker detection output based on the slice.

17. The at least one non-transitory machine-readable medium of claim 16, wherein the slice is a first slice, the difference signal is a first difference signal, and the instructions are to cause one or more of the at least one programmable circuit to:
merge at least the first slice and a second slice to determine a merged signal, the second slice segmented from a second difference signal associated with an adjacent image of the sequence of images relative to the current image;
transform the merged signal to generate a frequency domain signal; and
generate the flicker detection output based on comparison of a magnitude of a dominant frequency of the frequency domain signal to a threshold.

18. A system comprising:
a camera;
means for selecting images from the camera, the means for selecting to select a previous image of a sequence of images relative to a current image of the sequence of images based on comparison of a midpoint value of a flicker period to a time offset between the current image and the previous image; and
means for generating a flicker detection output based on the current image and the previous image.

19. The system of claim 18, wherein the means for generating is to:
sum pixel values across respective rows of a difference image to determine a difference signal associated with the current image, the difference image based on the current image and the previous image;
segment a slice from the difference signal based on zero crossings of the difference signal; and
generate the flicker detection output based on the slice.

20. The system of claim 19, wherein the slice is a first slice, the difference signal is a first difference signal, and the means for generating is to:
merge at least the first slice and a second slice to determine a merged signal, the second slice segmented from a second difference signal associated with an adjacent image of the sequence of images relative to the current image;
transform the merged signal to generate a frequency domain signal; and
generate the flicker detection output based on comparison of a magnitude of a dominant frequency of the frequency domain signal to a threshold.
